(19) United States
(12) Patent Application Publication
(10) Pub. No.: US 2017/0147872 A1
(43) Pub. Date: May 25, 2017

(54) METHOD OF IDENTIFYING A MOVEMENT BY QUANTIFIED RECURSIVE BAYESIAN FILTERING

(71) Applicant: Renaud Maroy, Paris (FR)

(72) Inventor: Renaud Maroy, Paris (FR)

(21) Appl. No.: 15/318,686

(22) PCT Filed: Jun. 24, 2015
(86) PCT No.: PCT/EP2015/064298

§ 371 Date: Dec. 14, 2016

(30) Foreign Application Priority Data
Jun. 25, 2014 (FR) 14 55913

(51) Int. Cl. G06K 9/00; G06K 9/52; A63F 13/211; A63F 13/833; A63F 13/44; A63F 13/332; G06F 17/18; A63F 13/213

(52) U.S. Cl. CPC G06K 9/00342; G06F 17/18; G06K 9/52; A63F 13/213; A63F 13/833; A63F 13/44; A63F 13/332; A63F 13/211; A63F 2300/1093; A63F 2300/638; A63F 2300/105

(57) ABSTRACT

The invention relates to a method for analyzing a movement by a human being, the method including the following steps:
selecting an initial probability function,
processing,
recognizing the end of the movement to be analyzed when a criterion is verified, the processing step being iterated for as long as the criterion is not verified,
determining a piece of information regarding the movement to be analyzed,
   each iteration of the processing step comprising a step for:
      providing a set of characteristic parameters relative to the movement to be analyzed during the chosen computing time interval,
      computing a point, the computed point belonging to a reference kinematic and making a function depending on the a posteriori conditional probability function extremal,
   the determination step taking into account the points computed upon each iteration of the processing step.

### TECHNICAL FIELD OF THE INVENTION

The present invention relates to a method for analyzing, and in particular identifying, a movement of a human being. The present invention also relates to a computer program product able to carry out the identification method. The present invention also relates to a recognition method implementing the identification method. The present invention also relates to a system for identifying a movement of a human being, in particular for a video game, able to carry out the movement identification method.

### BACKGROUND OF THE INVENTION

In the video game field, peripherals intended for game consoles allowing a player to control video games without using traditional controllers are being developed. In particular, acquisition devices providing access to parameters relative to a movement by the player exist. The Wiimote controller, the Kinect peripheral, the PlayStation Move system or the Razer Hydra are examples of such acquisition devices.

More specifically, the Wiimote controller, sometimes called “Wii Remote Control” or “Wii mote”, is the name of the controller for the Wii videogame console by Nintendo. The Wiimote controller is a rectangular controller generally held in one hand. Alternatively, the Wiimote controller is held in two hands. The Wiimote controller includes a plurality of sensors making it possible to identify the position of the controller in space and retranscribe movements of the controller to the screen. For example, in a first person shooting game, the Wiimote controller represents the weapon pointed only by moving the hand in the desired direction. This allows a new way of playing, more immersive depending on the builder.

The determination of the relative position of the Wiimote is obtained using a triangulation technique implemented by using a strip of several light-emitting laser diodes positioned above or below the screen. The Wiimote controller is thus capable of precisely and quickly computing the position of the controller relative to the strip and pointing to a precise spot on the screen. However, the Wiimote controller requires very precise pointing of the screen.

The Wiimote controller also has an accelerometer to determine the orientation of the controller (provision of different incline angles) and the position when the orientation does not make it possible to use triangulation.

Optionally, the Wii MotionPlus accessory is added to the Wiimote controller. Such an accessory provides the Wiimote controller with an additional gyroscopic sensor, i.e., a sensor able to measure an angular speed. The accessory allows a more faithful detection of the player's movement.

The Kinect peripheral is a peripheral intended for the Xbox 360 game console developed by Microsoft, making it possible to control video games without using a controller. The Kinect peripheral is also compatible with the Microsoft Windows operating system. The Kinect peripheral includes a camera working on the time of flight principle and a voice-recognition microphone. The camera is motorized to follow the player's movements. The Kinect peripheral uses interaction techniques making it possible to interact with the video game by voice command, movement and image recognition.

The PlayStation Move system is a peripheral for the PlayStation 3 video game console developed by Sony. The PlayStation Move system includes a camera, a movement detection controller comprising an accelerometer, a gyroscopic sensor and keys, and an optional navigation controller including additional keys. Like the Wiimote controller or the Kinect peripheral, the PlayStation Move system makes it possible to consider a new way of playing that is more immersive for the player.

The Razer Hydra module is a video game peripheral able to determine a player's movements. The Razer Hydra module uses weak magnetic fields to determine the absolute position and the orientation of the player with great precision.

However, independently of the considered peripheral, to guarantee optimal playing pleasure, it is desirable for the video game to react as quickly as possible to all of the player's movements. Such a reaction generally comprises moving a depiction of the player (an “avatar”), and optionally the reaction of an artificial intelligence unit.

Not understanding what the player is in the process of doing, i.e., not understanding the player's intention, would prevent artificial intelligence (AI) from reacting to the player's movements in time in a game requiring a reaction from the artificial intelligence during the player's movement. It is therefore desirable for the artificial intelligence to be capable of identifying the player's intention.

Such understanding would also make it possible, in a game where the player's or operator's movements are evaluated (such as a dance or tai chi movement evaluation game), to provide this evaluation in real time. It should be noted that such understanding is less crucial in a game with a controller, since when the player presses on a button or key, this generates a prerecorded movement of the player's avatar and allows the artificial intelligence or the evaluation method to determine the player's intention completely unambiguously and react accordingly. Nevertheless, this must be modulated by the case of games involving analog controllers, or a series of buttons or keys for which the preceding remark is already no longer true.

For example, in the case of a fencing game, it is necessary not only to recognize the fencing movement performed by the player clearly, but also for such recognition to be quick in order to ensure an appropriate reaction by the artificial intelligence. In the case at hand, the movement done by the artificial intelligence preferably takes into account the fencing movement performed by the player.

To that end, the article written by Sushmita Mitra and Tinku Acharya, titled “Gesture Recognition: A Survey” in the review IEEE Transactions on Systems, Man, and Cybernetics—Part C: Applications and reviews, volume 37, number 3 released in May 2007, discloses a set of movement recognition techniques allowing movement identification.

However, all of the techniques in the article have a long computing time, making the identification of the movements too slow for video game applications.

There is therefore a need for a method of identifying a movement by a human being having a shorter computing time.

### BRIEF DESCRIPTION OF THE INVENTION

To that end, proposed is a method of analyzing a movement of a human being, called movement to be analyzed, the movement to be analyzed having an end, the method being implemented by a computer including a memory unit storing a set of reference kinematics, each reference kinematic being a mathematical representation in the form of a series of points of at least one reference movement, each point yielding the value of a set of parameters characteristic of the represented reference movement(s), the method including the steps of choosing a computing time interval, selecting an initial probability function, processing, recognizing the end of the movement to be analyzed when a criterion is verified, the processing step being iterated for as long as the criterion is not verified, and determining a piece of information regarding the movement to be analyzed. Each iteration of the processing step comprising a step for providing a set of characteristic parameters relative to the movement to be analyzed during the chosen computing time interval, computing a point, the computed point belonging to a reference kinematic and rendering a function depending on a posteriori conditional probability extremal, called a posteriori conditional probability function, the a posteriori conditional probability function being defined for each point as the likelihood of the considered point being part of the movement to be analyzed knowing that all of the input parameters have been supplied, the input parameters being obtained from the supplied set of characteristic parameters and the a posteriori conditional probability function being computed by implementing a quantified recursive Bayesian filtering applied to the a posteriori conditional probability functions computed in the preceding iterations of the processing step and the initial probability function, the quantification relating to the reference kinematics. The determination step takes into account the points computed upon each iteration of the processing step.

The description also discloses a method of identifying a movement of a human being, called movement to be identified, the movement to be identified having an end, the method being implemented by a computer including a memory unit storing a set of reference kinematics, each reference kinematic being a mathematical representation in the form of a series of points of at least one reference movement, each point yielding the value of a set of parameters characteristic of the represented reference movement(s), the method including the steps of choosing a computing time interval, processing, recognizing the end of the movement to be identified when a criterion is verified, the processing step being iterated for as long as the criterion is not verified, determining the movement that is most representative of the movement to be identified, the most representative movement being a reference movement or a series of parts of reference movements. Each iteration of the processing step comprises a step for providing a set of characteristic parameters relative to the movement to be identified during the chosen computing time interval, computing a point, the computed point belonging to a reference kinematic and rendering a deviation function between input parameters and the points of the reference kinematics extremal, the input parameters being obtained from the supplied set of characteristic parameters. The determination step takes into account the points computed upon each iteration of the processing step.

The description also discloses a method of identifying a movement of a human being to be identified, the movement having an end, the method being implemented by a computer including a memory unit storing a set of reference kinematics, each reference kinematic being a mathematical representation in the form of a series of points of at least one reference movement, each point yielding the value of a set of parameters characteristic of the represented reference movement(s), the method including the steps of choosing a computing time interval, processing, recognizing the end of the movement by the human being when a criterion is verified, the processing step being iterated for as long as the criterion is not verified, determining the movement that is most representative of the movement to be identified, the most representative movement being a reference movement or a series of parts of reference movements. Each iteration of the processing step comprises a step for providing a set of characteristic parameters relative to the movement to be identified during the chosen computing time interval, for computing paths, a path being a series of points, said points each belonging to or being associated with a reference kinematic, the computing step comprising deducing, according to a first rule, the following point(s) of each path, to obtain a set of authorized paths, each deduced point belonging to or being associated with a reference kinematic and depending on input parameters, the input parameters being obtained from the set of supplied relative characteristic parameters, and the selection among the authorized paths of a set of optimal paths, according to a second rule. The determining step takes the computed paths into account.

The description also discloses a method of identifying a movement of a human being, called movement to be identified, the method being implemented by a computer including a memory unit storing a set of reference kinematics, each reference kinematic being a mathematical representation in the form of a series of points of at least one reference movement, each point yielding the value of a set of parameters characteristic of the represented reference movement(s), the method including a step for identifying the movement that is most representative of the movement to be identified through a computation, the most representative movement being a series of reference kinematic parts, the series including a first number of reference kinematic parts, the first number being an integer greater than or equal to 1, and reducing the number of possible transitions between two separate reference kinematics by using at least one penalty rule, each penalty rule penalizing at least one transition between two reference movement kinematics in the most representative movement, the reduction step being carried out during the implementation of the identification step.

According to specific embodiments, the analysis or identification method includes one or more of the following features, considered alone or according to any technically possible combinations:
the penalty rule is a binary rule.
the identification step is iterative and each reference kinematic part has a starting state and an arrival state, and in the reduction step, a used penalty rule associates a penalty with a transition from a reference kinematic part identified in a previous iteration of the identification step toward an additional reference kinematic part, when the starting state of the additional part is different from the starting state of the identified reference kinematic part and the final state of the identified reference kinematic part.
the identification step includes an iterative processing step comprising computing a score function associated with the identification of a reference kinematic part for a part of the movement to be identified and in the reduction step, a used penalty rule associates a penalty with a transition from a reference kinematic part and/or to an additional reference kinematic part, depending on the score functions associated during previous iterations with said reference kinematic parts.
each part of each reference kinematic is associated with one or several other reference kinematic parts by an association accompanied by a cost and a penalty rule used prohibits the transitions between non-associated reference kinematic parts and penalizes transitions between two associated reference kinematic parts by the value of the cost accompanied by the association of the two considered reference kinematic parts.
the identification step is iterative and wherein the method includes a step for measuring the distance actually traveled by the human being, in order to obtain a measured distance, and, in the reduction step, a used penalty rule penalizes the transition from a reference kinematic part identified in a previous iteration of the identification step to an additional reference kinematic part with a value depending on the deviation between the measured distance and the distance traveled from the reference kinematic part identified in the previous iteration of the identification step to the additional reference kinematic part.
in the reduction step, a penalty rule penalizes the presence of two parts of a same reference movement not respecting a predefined order.
the movement to be identified has an end and the identification step is carried out by implementing an identification method as previously described.
each iteration of the processing step further includes a step for selecting the reference kinematic by minimizing a cost function taking into account the points computed in the previous iterations of the processing step, the cost function preferably being the deviation function used in the computing step.
each iteration of the processing step further includes a step for detecting a change of reference kinematic if the reference kinematic selected in the selection step of the considered processing step is different from the reference kinematic selected in the previous iteration of the processing step.
according to the first rule, a single point is computed for the considered path if the series of points computed in the previous iteration for the considered path has an energy exceeding another series of points computed in the previous iteration of the processing step.
according to the second rule, if a deduced point belongs to two different paths, only the path whose series of points has a minimal energy is selected.
the analysis method is an identification method, the movement to be analyzed being a movement to be identified, the determination step being a step for determining the movement that is most representative of the movement to be identified, the most representative movement being a reference movement or a series of reference movement parts,
the function depending on the a posteriori conditional probability function is the identity function.
each iteration of the processing step comprises a step for obtaining input parameters from the set of provided characteristic parameters.
the method is a method for predicting the movement to be analyzed, the information pertaining to at least one following point of the movement.
the method is a method for filtering the movement to be analyzed.
the input parameters are the set of provided characteristic parameters.
a minimal performance time being defined for the reference movements, the chosen computing time is less than the minimum time to perform a reference movement.
a minimal performance time being defined for the reference movements, the chosen computing time is less than one tenth of the minimum time to perform a reference movement.
the method further includes a step for selecting a starting point, the starting point belonging to a reference kinematic.
the step for obtaining input parameters includes a step for sequencing the provided characteristic parameters in a predefined order.
the step for obtaining input parameters includes a step for projecting the provided parameters in an orthogonal base.
the orthogonal base is obtained by implementing a primary component analysis applied to all of the reference kinematics.
the step for obtaining input parameters includes a step for normalizing the provided parameters to the size of the human being.
the step for obtaining input parameters includes a step for checking the validity of the provided characteristic parameters.
said at least one derived and/or integrated parameter is independent of the speed of the movement to be identified.
the provision step is implemented by at least one acquisition device able to acquire characteristic parameters relative to the movement of the human being to be identified, the provision step including a step for measuring the characteristic parameters and a step for sending the measured characteristic parameters to the computer, the measured characteristic parameters being the provided characteristic parameters.
the determination step is carried out by minimizing a cost function.
each iteration of the processing step also includes a step for choosing the computing time interval for the following iteration.
each iteration of the processing step also includes a step for choosing the computing time interval for the iteration in progress.
the deviation function comprises a weighting of the input parameters depending on one or several elements of the group made up of the nature of the parameter and the uncertainty of the measurement of the parameter.
the set of characteristic parameters relative to the movement of the human being to be identified during the chosen computing time interval is the position of n joints of the human being, n being a strictly positive integer.
the set of input parameters during the chosen computing time interval comprises, for each joint of the human being, the differences in position between two adjacent joints of the human being, the spatial derivatives of each of the differences and/or the spatial integral of each of the differences.
the integer n is greater than or equal to 6, preferably greater than or equal to 40, preferably greater than or equal to 60.
the number of reference kinematics is greater than or equal to 500, preferably greater than or equal to 900, preferably greater than or equal to 3000.

Also proposed is a method of recognizing a movement of a human being, called movement to be identified, the movement to be identified having an end, the method being implemented by an acquisition device and a computer including a memory unit, the method including the following steps: the human being performs reference movements, the acquisition device acquires characteristic parameters relative to the reference movements performed, a set of reference kinematics is determined, each reference kinematic being a mathematical representation in the form of a series of points of at least one reference movement, each point yielding the value of a set of parameters characteristic of the represented reference movement(s), placing all of the determined reference kinematics in memory, carrying out the steps of the identification method as previously described.

According to one particular embodiment, the step for determining a set of kinematics is carried out by a learning technique. Preferably, the learning technique is a gradient descent.

Furthermore, also proposed is a computer program product including programming code instructions able to be implemented by a computer, in particular a video game for a video game console, the computer program being able to carry out the analysis method as previously described.

Also proposed is a system for identifying a movement by a human being, called movement to be identified, in particular for a video game, including a computer including a memory unit, and a device for acquiring a set of characteristic parameters relative to the movement to be identified, the movement having an end. The memory unit stores a set of reference kinematics, each reference kinematic being a mathematical representation in the form of a series of points of at least one reference movement, each point yielding the value of a set of parameters characteristic of the represented reference movement(s), and the computer is able to carry out the following steps: choosing a computing time interval, selecting an initial probability function, processing, recognizing the end of the movement to be identified when a criterion is verified, the processing step being iterated for as long as the criterion is not verified, and determining the movement that is most representative of the movement to be identified, the most representative movement being a reference movement or a series of parts of reference movements. Each iteration of the processing step comprises a step for providing, via the acquisition device, a set of characteristic parameters relative to the movement to be identified during the chosen computing time interval, computing a point, the computed point belonging to a reference kinematic and rendering a function depending on a posteriori conditional probability extremal, called a posteriori conditional probability function, the a posteriori conditional probability function being defined for each point as the likelihood of the considered point being part of the movement to be identified knowing that all of the input parameters have been supplied, the input parameters being obtained from the supplied set of characteristic parameters and the a posteriori conditional probability function being computed by implementing a quantified recursive Bayesian filtering applied to the a posteriori conditional probability functions computed in the preceding iterations of the processing step and the initial probability function, the quantification relating to the reference kinematics. The determination step takes into account the points computed upon each iteration of the processing step.

The description also discloses a processing method for computing a function relative to a first event, the set of events being able to be represented by an initial hidden Markov model, the initial hidden Markov model being characterized by states, observations, a matrix of transition probabilities between the states, and observation probability parameters for each state, each event being characterized by a temporal sequence of states and a temporal sequence of observations, the processing method being implemented by computer. The processing method comprises the steps for providing a first constraint function, a step for defining a first current computing matrix such that the image of the first current computing matrix by the first constraint function is the set of observation probability parameters for each state, a step for providing a second constraint function and a step for defining a second current computing matrix such that the image of the second current computing matrix by the second constraint function is the matrix of the transition probabilities between the states. At least one of the two constraint functions being such that at least one of the following conditions is verified: the number of elements of the first current computing matrix is lower than the number of elements of the observation probability parameters, and the size of the second current computing matrix is smaller than the size of the matrix of transition probabilities between the states. The processing method also includes a step for providing at least the temporal sequence of observations for a second event, a step for optimization by minimization of an optimization function to obtain a first optimal computing matrix and a second optimal computing matrix, the optimization function having, as input variable, the first current computing matrix and the second current computing matrix and the optimization function depending at least on the temporal sequence of observations provided for the second event and a step for computing the function relative to the first event from the first optimal computing matrix and the second optimal computing matrix.

According to specific embodiments, the processing method includes one or more of the following features, considered alone or according to any technically possible combinations:
the function relative to the first event is an inference, filtering, smoothing, probability of an observed sequence, probabilities of latent variables or likeliest explanation function.
one of the two constraint functions is the identity function.
at least one of the two constraint functions is not the identity function.
at least one of the two constraint functions also depends on a third, time-dependent matrix.
the third matrix is a function of the observations.
the optimization function is a set of two functions, one optimizing only the first current matrix and the other optimizing only the second current matrix.
the initial hidden Markov model is a left-right Markov model.
the second constraint function g depends on several variables.

Also proposed is a voice recognition method including the use of the processing method as previously described.

Also proposed is a method of identifying a movement of a human being, called movement to be identified, the movement to be identified having an end, the method being implemented by a computer including a memory unit storing a set of reference kinematics is determined, each reference kinematic being a mathematical representation in the form of a series of points of at least one reference movement, each point yielding the value of a set of parameters characteristic of the represented reference movement(s), the method including the use of the processing method as previously described, the set of events being the set of reference kinematics, the states being the points of the different reference kinematics and the observations of the input parameters obtained from a set of characteristic parameters provided during a chosen computing time interval.

According to specific embodiments, the analysis or identification method includes one or more of the features previously mentioned for the analysis and/or identification method, considered alone or according to any technically possible combinations.

Also proposed is a method of recognizing a movement of a human being, called movement to be identified, the movement to be identified having an end, the method being implemented by an acquisition device and a computer including a memory unit, the method including the following steps: the human being performs reference movements, the acquisition device acquires characteristic parameters relative to the reference movements performed, a set of reference kinematics is determined, each reference kinematic being a mathematical representation in the form of a series of points of at least one reference movement, each point yielding the value of a set of parameters characteristic of the represented reference movement(s), placing all of the determined reference kinematics in memory and carrying out the steps of the identification method as previously described.

According to one particular embodiment, the step for determining a set of kinematics is carried out by a learning technique. Preferably, the learning technique is a gradient descent. According to another embodiment, the learning technique is the Baum-Welch algorithm.

Furthermore, also proposed is a computer program product including programming code instructions able to be implemented by a computer, in particular a video game for a video game console, the computer program being able to carry out the processing method as previously described or the voice recognition method previously described or the method for identifying a movement of a human being as previously described.

Also proposed is a system for identifying a movement by a human being, called movement to be identified, in particular for a video game, including a computer including a memory unit, and a device for acquiring a set of characteristic parameters relative to the movement to be identified, the movement to be identified having an end. The memory unit stores a set of reference kinematics, each reference kinematic being a mathematical representation in the form of a series of points of at least one reference movement, each point yielding the value of a set of parameters characteristic of the represented reference movement(s). The computer is able to implement the use of the processing method as previously described, the set of events being the set of reference kinematics, the states being the points of the different reference kinematics and the observations of the input parameters obtained from a set of characteristic parameters provided during a chosen computing time interval.

### BRIEF DESCRIPTION OF THE DRAWINGS

Other features and advantages of the invention will appear upon reading the following description of embodiments of the invention, provided as an example only and in reference to the drawings, which are:

FIG. 1, a schematic illustration of a system for identifying a movement by a human being,

FIG. 2, a flowchart showing the implementation of one example identification method comprising one or several iterations of a processing step,

FIG. 3, a flowchart of an example embodiment of a processing step according to a first embodiment of the identification method including an obtainment step,

FIG. 4, a flowchart of an example embodiment of the obtainment step of the processing step of FIG. 3,

FIG. 5, a flowchart of an example embodiment of a processing step according to a second embodiment of the identification method,

FIG. 6, a flowchart showing the implementation of one example processing method according to a third embodiment comprising one or several iterations of a processing step,

FIG. 7, a flowchart of an example embodiment of a processing step according to the third embodiment,

FIG. 8, a flowchart of an example implementation of a processing method,

FIG. 9, a flowchart of an example embodiment of a processing step according to a fifth embodiment of the identification method, and

FIG. 10, an example flowchart of an implementation of a recognition method.

### DETAILED DESCRIPTION OF THE INVENTION

Possible Uses of the Identification System and Choice of the Example of Fencing

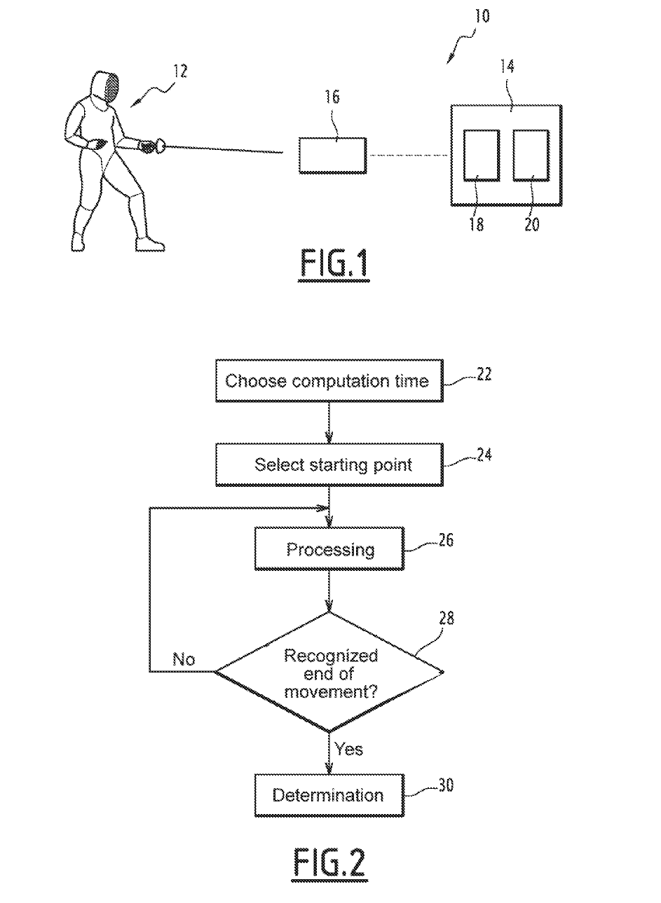

A system for identifying a movement by a human being, hereinafter referred to as the system 10, and a human being 12 are shown in FIG. 1.

The system 10 is able to identify a movement by the human being 12. Hereinafter, it is assumed that the movement to be identified has a beginning and an end.

According to the example of FIG. 1, the human being 12 is a fencing player.

In the illustrated example, the system 10 is used to identify the movements of the human being 12 for a video game application. More specifically, the system 10 serves to provide the elements making it possible to obtain an avatar representative of the intention of the human being 12. As a result, hereinafter, the human being is referred to as the player 12.

According to one alternative, the system 10 serves to provide the elements corresponding to a reaction from the artificial intelligence.

However, the applications of the system 10 are not limited to the video gaming sector. The system 10 is usable in any other field involving the identification of at least one movement by the human being 12. As an example, the system 10 is usable in the robotics industry or for dispensing and/or ordering automatons. In the case of dispensing automatons, the choices by the user of the automaton are made by identifying gestures by the user.

For illustrative purposes, in the rest of the description, the use of the system 10 is illustrated for a complex video game. Combat games historically being part of video gaming, it seems appropriate to choose a combat game. Among combat games, fencing (or combat with a weapon) makes it possible to do away with the agility and flexibility required for martial arts, since fencing essentially consists of good perception and good decision-making to perform the desired movement without giving the opponent opportunities. Furthermore, fencing has also been chosen due to its high degree of complexity and the position of the player, which is particularly unfavorable for the system 10. Demonstrating the good applicability of the system 10 to fencing thus makes it possible to consider the application of the system 10 for any other game, whether combat or not, the movements of which will a priori be less complex.

To understand the complexity of fencing, several precisions regarding fencing should be introduced before describing the system 10 in greater detail. In the context of a video gaming application, various types of fencing can be considered: athletic fencing, traditional fencing with a sword, saber or bayonet, or medieval fencing with a short sword, a two-handed sword, a lance, an axe, a halberd, a staff, etc. Hereinafter, only saber fencing is more specifically considered.

In such a scenario, it involves the art of touching an opponent with the point or edge (rapier and cutting edge) of a bladed weapon on the valid parts without being touched. Pure strength, even in fencing or saber, is not the most important quality. It is better to think (quickly) before acting, the relevancy (knowing how to react appropriately and at the right time) being the most important quality of a fencer. Like all other sports, fencing demands concentration, agility, endurance, as well as technique. Several positions are outlined below.

The fencer, having his weapon in hand, sits on his legs, the right one forward, the point of the foot slightly to the outside; the left leg bearing the body weight slightly more is also bent, the left foot transversely placed flat, the two heels squared. The torso is withdrawn; the right arm is half-tensed, the hand even with the tip of the sternum, the wrist in quarte, tierce, prime or seconde; the left arm is raised, rounded, such that the left hand is even with the head. Thus placed, the fencer is en garde. The en garde position is the most favorable position assumed by the fencer in order to be ready for the defensive, the offensive or the counter-offensive. It should be noted that the en garde position experiences modifications during combat, depending on the chosen tactic.

Although the orientation of the body always remains substantially the same in fencing, there are different ways to position the fencer's weapon, so that the fencer has the option of implementing various offensive or defensive techniques.

To distinguish the position of the weapon, in fencing, there are four lines, namely the high line, the low line, the outside line and the inside line. The high line is a line along which the opponent's attacks occur passing above the fencer's hand, while the low line is the line along which the opponent's attacks occur passing below the fencer's hand. The outside line corresponds to the right part of the body, by far the narrowest, while the inside line corresponds to the left part, the broadest.

The simple attacks by the fencer occur along each of the four preceding lines. “Simple attack” refers to the initial offensive action performed by extending the arm, the point threatening the valid surface and coordinated with a progression of thrusts forward (lunge, flèche). Each of the simple attacks is associated with a parry, i.e., a defensive action intended to make sure that a riposte is obtained and to touch the opponent. In principle, due to the four lines, four opposing parries would suffice.

However, it is possible for each parry to keep the weapon in the pronated position (nails under the hand) or supine position (nails above the hand). The same principle applying to the attacks, there are also eight orientations of the wrist, or equivalently, positions of the weapon to attack.

Thus, there are in particular the following movements, knowing that typically, the positions of the weapon are identified by numbering the positions from 1 to 8. Hits with the saber are reduced to the quarte hit and the tierce hit, the blade of the saber being too heavy and not manageable enough to effectively perform the other hits. For simplification, only the most typical movements are discussed hereinafter:
For position 1, called prime (low line/hand pronated/low point), prime hit 8 at the crotch point, the prime parry, the low prime parry and the high prime parry. This is the first movement that the attacked fencer performs when he draws the sword from the sheath to strike or cover himself. The sword is then vertical, the point down; the nails of the hand at face height are facing downward. This is the prime guard leading to an attack, the point diving; in a parry, the point low and allowing two ripostes, and one provided to the right, the other by cutting above the blade.
for position 2, called seconde (outside line/hand pronated/low point), the seconde hit 4 at the cheek, the seconde hit 4 at the leg, the high seconde parry and the seconde parry. This is the second movement that one naturally performs to cover oneself if the opponent has deceived the prime parry; one lowers the wrist and elbow, the point of the sword turned to the right, downward, the nails underneath.
for position 3, called tierce (high line/hand pronated/high point), the tierce hit 2 at the cheek, the tierce hit 2 at the leg, the horizontal tierce hit 6 at the side, the horizontal tierce hit 6 at the throat, the tierce hit, the high tierce parry, the low tierce parry and the tierce parry. If the seconde parry is deceived, the enemy sword threatens in the outside and upper line; one holds one's sword with the point higher, the nails underneath, the horizontal forearm able to riposte or attack in the low line.
for position 4, called quarte (inside line/hand supinated/high point), the quarte hit 1 at the cheek, the quarte hit 1 at the leg, the quarte hit, the horizontal quarte parry, the low quarte parry, the high quarte parry and the quarte parry. This is a movement to oppose against the enemy sword returning to threaten the inner high line; the competitor draws his sword, the point high, the nails upward, threatening his opponent in the inner line.
for position 5, called high quinte (inside line/hand pronated/point high or horizontal), the quinte blow 7 to the head. This involves covering the left flank. The lowered sword is held with the nails on the side slightly high, the thumb clearly above; the parry, also called the Saint George, results in raising the enemy sword, leaving the two low lines exposed.
for position 6, called sixte (high line/hand supinated/point high), the sixte parry. This is a movement covering the right side; the fencer holds his sword with the point high, threatening his opponent's outer line, the hand having the nails upward. The fencer then parries with the false edge.
for position 7, called septime (low line/hand supinated/low point), the septime hit 3 at the cheek, the septime hit 3 at the leg and the septime parry. This movement consists of covering or threatening the bottom line of the weapons; for the parry; to this end, the fencer lowers the point of the sword inside while causing it to describe a half-circle from right to left, the hand having the nails to the outside, slightly upward; the septime parry constitutes a half-circle.
for position 8, called octave (outside line/supinated position/low point), the high octave parry and the octave parry. This involves the movement covering the outer line; the sword is nearly vertical, the point down, the hand having the nails upward and slightly inside.

Other standard hits exist. The en garde attack return, the en garde parry return, the manchette hit or the contre-de-sixte are other examples of this.

Furthermore, in the case of the attack, how the attack is done should also be considered, the attack being able to be simple or complex.

A simple attack is, by definition, done in a single step. It is generally considered that there are only three ways of performing a simple attack. These are the straight thrust, the coupé or the disengagement. The straight thrust, as its name indicates, is a touch done straight on (while staying in the same line). The coupé consists of changing the side of one's blade relative to the opposing blade, bypassing it by passing above the point, before performing the touch. The disengagement consists of performing the touch after having changed the blade's side relative to the opposing blade by bypassing it via the opponent's guard.

A complex attack is a simple attack preceded by one or several feints. The most commonly used are the “one-two” and the “double” (a disengagement or coupé feint followed by a disengagement (called “deception”) that consists of avoiding the opposing parry), the coupé-coupé feint, etc., all while changing horizontal and/or vertical and/or diagonal line.

In both cases, according to one alternative, the simple or complex attack is preceded by attack preparations such as attacks with the blade, taking of the blade or contact of the blades. This is true for the sword and the foil, but for the saber, the different movements are primarily the simple hit, the moulinet, or the half-moulinet.

It should also be considered that the parry is merely a means of defense. The retreat making it possible to avoid being touched while keeping the opponent at a distance, the displacement, which is a movement that moves part of his body away so as not to be touched or the counter-attack making it possible to touch before the opponent on his attack without moving his blade away are other examples of defense.

In general, any combination of the preceding gestures can be considered in the case of a weapon cross between two opponents with the ability to ensure continuity of the gesture. These are the feints. As a complex example, a feint is done by performing a false attack that results in destabilizing the opponent, then another feint is done when the opponent performs the first parry.

In the context of the present description, only the elements previously mentioned are considered for simplification reasons, since with all of the combinations already considered, this corresponds to a set of about 900 fencing movements that sometimes differ only by a single spatial position or the order in which they are performed.

However, in reality, to be thorough, the movements of the fencer should also be taken into account, such as the advance, the retreat, the jump forward, the jump backward, the front cross, the ballestra, the double lunge, the flèche or the extension.

Thus, hereinafter, it is considered that fencing can be represented by 900 reference movements.

Description of the Identification System

The system 10 includes a computer 14 and a device for acquiring a set of characteristic parameters relative to the movement of the player 12, said movement to be identified, hereinafter called the device 16. The memory unit 18 is able to store a set of reference kinematics.

Each reference kinematic is a mathematical representation in the form of a series of points of at least one reference movement. A reference movement is a movement representing a movement type.

In the case of fencing considered in the present description, it is difficult to acquire an overview of the fencing movements, and in particular as pertains to the movement itself and as pertains to the relevance of the reaction to the opponent's gestures. For the rest of the description, it is assumed that there are 900 types of movements, and 30 reference movements per movement type.

Each point, or equivalently each location, on a reference kinematic yields the value of a set of parameters characteristic of the represented reference movement(s). A characteristic parameter is an observable of the player 12, i.e., a parameter that can be measured by a sensor. In the context of the invention, the characteristic parameter is a kinematic parameter. In physics, kinematics is the study of movements independently of the causes producing the movements. Kinematics is thus based on the notions of space and time. The characteristic parameters are chosen from the group made up of parameters relative to the space or parameters relative to the evolution of the movement. A length, a position or an angle are examples of parameters relative to the space. The characteristic parameters are for example the position of joints of a human being. A speed, acceleration, an angular speed or an angular acceleration are examples of parameters relative to the evolution of the movement.

Each parameter can be expressed a priori in a two-dimensional or three-dimensional plane of reference. As an example illustration, for a case with a single dimension, there are seven parameters per joint (3 for positions, 3 for tangents and 1 for a curved abscissa), twenty joints being considered. This means that at each moment, there are 140 parameters. Furthermore, according to one preferred embodiment, each parameter for the twenty joints is recorded at a frequency of about thirty points per second. Thus, each reference kinematic represents the evolution over time of the parameters characteristic of a reference movement. In other words, each kinematic is a series of points in time or states, each state or point in time corresponding to the value of the characteristic parameters at the moment in question. This in particular means that, for each kinematic, it is possible to define a starting state and an arrival state.

Hereinafter, according to the most convenient representation, the points, points in time or states are used indifferently.

The set of reference kinematics forms a database, hereinafter called knowledge base.

One example method making it possible to obtain reference kinematics is described in reference to the paragraph titled “Establishment of a knowledge base”.

The processor 20 is able to carry out a method for identifying the movement to be identified. Alternatively, the processor 20 is also able to carry out a method for recognizing the movement to be identified.

According to one advantageous embodiment, the computer 14 is a video game console.

The device 16 is able to acquire a set of characteristic parameters relative to the movement of the player 12.

More specifically, the device 16 allows an effective determination of the intention of the player 12, and also changes in the intention of the player 12 in “real-time” or “on the fly”, or in other words each time a new acquisition point is acquired. Furthermore, the fewest resources possible are monopolized, since in the opinion of development studios, the majority of the resources of the computer 14 should be dedicated to graphics and sound.

To obtain such an effect, the device 16 includes one or several sensors able to perform measurements on the movement of the player 12.

As an illustration, one of the sensors is a camera. For example, the camera is a camera able to operate in the infrared band, i.e., the camera is able to detect photons having a wavelength comprised between the visible domain and the microwave domain. Typically, such photons have a wavelength comprised between 800 nanometers and 1 millimeter.

According to one preferred embodiment, the camera is able to detect the entire body of the player 12. Advantageously, the camera is able to provide information relative to the position of several joints of the human body. Preferably, the number of joints of the human body for which the camera is able to provide information is greater than or equal to 10, preferably greater than or equal to 20.

According to one particular embodiment, the camera is a camera operating on the time of flight principle. According to another embodiment, the sensor of the device 16 is an accelerometer making it possible to determine the orientation of an object. According to another embodiment, the sensor of the device 16 is a gyroscopic sensor.

In general, any sensor making it possible to provide indications on the position and orientation of the player 12 can be considered.

Alternatively, the sensor is also able to provide the position of the ground relative to a predefined reference. To that end, according to one embodiment, the sensor is able to provide the equation of the ground in a predefined reference.

Preferably, the device 16 includes a plurality of sensors, in particular any combination of the previously mentioned sensors. For example, the combination of a camera and an accelerometer is of particular interest, as well as the combination of a camera, an accelerometer and a gyroscopic sensor.

According to one embodiment, the device 16 is a peripheral of the computer 14. The device 16 and the computer 14 are suitable for communicating with one another, whether through a wired or wireless connection. According to one specific embodiment, the device 16 is also able to perform computations on the acquired parameters or to assign degrees of reliability to the measured parameters. For such an assignment, in the simplest case, the measured parameters are either associated with a “reliable” attribute, or associated with an “unreliable” attribute.

Preferably, the number of parameters is greater than or equal to 6, preferably greater than or equal to 40, preferably greater than or equal to 60.

According to one alternative that is not shown, the system 10 also includes a display unit, for example a monitor. The display unit may or may not be part of the computer 14, depending on the case.

Shortcomings of an Identification Method According to the State of the Art

Notwithstanding the problems of modeling fencing or modeling a movement, as previously seen, the identification method is a “real-time” targeted method with a computation time of less than 30 ms (milliseconds) to adapt to an application in the video game field. Such a computation time is relatively short to recognize the movement of the player 12 from among a knowledge base of potentially several hundred, or even several thousand reference movements. In the example used in the context of the present application, only 900 reference movements are considered for a very simplified model of saber fencing, knowing that each reference movement corresponds to about fifty points per movement, each point representing the values of 60 parameters. From a computer perspective, the dimensionality (computation complexity) of the problem to be addressed is very high.

Furthermore, the method should indicate the intention of the player 12, or in other words, the reference movement that the player 12 is in the process of performing. Indeed, in a video game, the artificial intelligence reacts to the player's movements without waiting for the end of the movement. As an example, still in the case of a fencing game, if the artificial intelligence has not yet begun to react at the end of the offensive movement (which, as previously explained, comprises one or several feints), the character controlled by the artificial intelligence is dead. In other words, as the movement by the player 12 takes place, the identification method should allow the best possible understanding of the movement by the player 12, despite the potentially large number of reference movements.

Next, the movement to be identified being continuous, it is also desirable for the proposed identification method to be able to segment the movement to be identified, in other words, to determine when the player 12 changes movement, automatically. The identification method then makes it possible to go from a completed movement to a beginning movement flexibly and continuously, but also to interrupt one movement to perform a second one, which corresponds to a feint in fencing.

To that end, many algorithms have been tested by the applicant, such as Kalman filtering, the normality and linearity hypotheses of which make use impossible for the system 10, the extended Kalman filter, particle filtering, the hidden Markov models (HMM), neuron networks, the configuration states method, the Support Vector Machine (SVM) method, the Dynamic Time Warping method, the Soft-max classification method, the temporal correlation of the data or dictionary-based methods.

None of these methods are able to perform an online movement identification in a short amount of time (compatible with a “real-time” game) on such a large number of movement types (more than 900 in the case at hand). On the contrary, the identification methods that are described in the continuation of the description make it possible to fulfill the aforementioned criteria.

Hereinafter, an identification method according to a first embodiment is proposed. Very schematically, to summarize, such an identification method is a projection of the last points of the acquired movement on the average movements of the different reference kinematics. The identification method according to the first embodiment is quite generally described in the paragraph titled “Method for identifying a movement by a player 12 by minimizing a functional”.

An identification method according to a second embodiment is proposed. Very schematically, to summarize, such an identification method is able to identify a movement by building active contours, or snake, through a dynamic programming mechanism based on the Sethian Fast Marching Method to find the globally minimum active energy contour. Specifically to the identification method according to the second embodiment, the active contours are made up of points belonging to the average movements of the clusters of movement classes. Furthermore, an active contour does not need to belong to just one cluster of a movement class. The active contour has permission to jump from one cluster to another, with a certain cost. Furthermore, the very large majority of the paths die, i.e., are eliminated due to the non-locally minimal nature of their energy. Furthermore, some paths are not built due to the non-locally minimal nature of their energy in the preceding step. The identification method according to the second embodiment is quite generally described in the paragraph titled “Method for identifying a movement by a player 12 within the knowledge base by minimizing the energy of paths built from movement points of the knowledge base”.

Hereinafter, an identification method according to a third embodiment is proposed. Very schematically, to summarize, such an identification method is a technique for determining the most probable movement point (the most probable state according to the standard terminology), knowing that certain parameters have been observed (observable according to the standard terminology). This determination is based on a quantified recursive Bayesian filtering. Specifically, the grid used in this context applies, unlike the typical quantified recursive Bayesian filtering methods, to the reference kinematics (i.e., to the space of the states) and not to the observed parameters (i.e., the space of the observables). The identification method according to the third embodiment is quite generally described in the paragraph titled “Method for identifying a movement by a player 12 by using quantified recursive Bayesian filtering”.

Hereinafter, an identification method according to a fourth embodiment is proposed. Very schematically, to summarize, such an identification method is based on a simplification of the hidden Markov model. The identification method according to the fourth embodiment is quite generally described in the paragraph titled “Method for identifying a movement by a player 12 by using a simplification of the hidden Markov model”.

An identification method according to a fifth embodiment is proposed. Very schematically, to summarize, such an identification method introduces a penalty into an identification method of the state of the art or the four aforementioned methods by using penalty rules for introducing a transition between two parts, potentially separate, of reference movements. Fifth embodiment is quite generally described in the paragraph titled “Method for identifying a movement by a player 12 by reducing the number of possible transitions”.

Method for Identifying a Movement by a Player 12 by Minimizing a Functional

The operation of the system 10 will now be described in reference to FIGS. 2 to 4, which illustrate an example implementation of the method for identifying the movement to be identified according to a first embodiment.

FIG. 2 more specifically shows the iterative architecture of the proposed identification method. FIG. 2 is more specifically described below.

The identification method includes a step 22 for choosing a computation time interval.

According to one embodiment, step 22 is carried out by having an operator enter a computation time interval. Alternatively, the computer 14 is able to determine the computation time interval automatically. In particular, when the computation points are replaced by averages, an excessively short computation time interval does not allow a real-time computation, while with an excessively long computation time interval, the central trend moves away from the actual shape of the movement and a movement change by the player 12 may not be detected.

Preferably, when a minimal performance time is defined for the reference movements, the chosen computing time is less than the minimum time to perform a reference movement. Preferably, the chosen computing time is less than one tenth of the minimum time to perform a reference movement. According to another embodiment, the computation time is determined on the fly before each processing operation.

The identification method also includes a step 24 for selecting a starting point. According to one alternative, the step 24 for selecting a starting point being optional, the identification method does not comprise step 24 for selecting a starting point. According to one embodiment, the selection step 24 allows the selection of a starting point for each reference kinematic.

In the selection step 24, the computer 14 selects a starting point, the starting point belonging to a reference kinematic. According to one preferred embodiment, the starting point is chosen by taking the position of the player 12 into account when the computer 14 carries out the selection step 24. In such a case, the computer 14 orders the device 16 to acquire parameters related to the actual position of the players. The device 16 acquires the parameters and, through a minimization, the point of a reference kinematic having the shortest distance from the acquired parameters is chosen. According to one alternative embodiment, the starting point is chosen to favor the convergence of the computations done during the identification method.

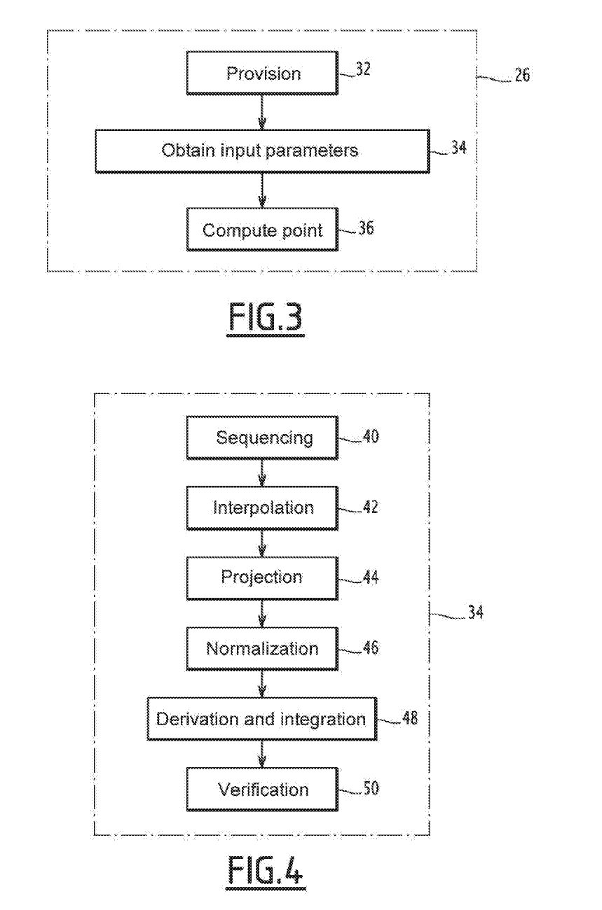

The identification method also includes a processing step 26. The processing step 26 is described more specifically in reference to FIG. 3.

The identification method also includes a step 28 for recognizing the end of the movement by the player 12.

The recognition step 28 is a test step according to a criterion.

When the criterion is not fulfilled, the processing step 26 is carried out again.

When the criterion is fulfilled, the identification method is continued by a step different from the processing step 26.

The recognition step 28 is implemented by the computer 14.

As an example, the criterion is a time delay. In this case, the time interval elapsed between the first iteration of the processing step 26 and the current iteration of the processing step 26 is compared to a predefined time interval. As long as the elapsed time interval is strictly smaller than the predefined time interval, the processing step 26 is carried out again. According to another embodiment, the criterion is the number of iterations of the processing step 26, the number of iterations being limited to a predefined number of iterations. According to a more sophisticated alternative, the criterion takes the results of the processing step 26 into account. For example, it is explained hereinafter that according to one specific case, the processing step 26 comprises a determination of a change of reference movement by the player 12 (case of a feint). The criterion is then a limitation of the number of changes of reference movement. For example, after two changes of reference movement, the identification method is continued by a step different from the processing step 26.

Thus, step 28 is a step for recognizing the end of the movement by the human being when the criterion is fulfilled, the processing step 26 being iterated as long as the criterion is not fulfilled.

The identification method also includes a step 30 for determining the reference movement(s) representative of the movement by the player 12.

“Representative” means that the reference movement(s) are closest within the meaning of a predefined criterion of the movement by the player 12. Such proximity applies both for the reference movement as a whole and for part of the reference movement. Voss, step 30 corresponds to the determination of the reference movement(s) at least part of which is closest within the meaning of a predefined criterion of the movement by the player 12.

Additionally and optionally, the determination step 30 also seeks to determine the series of reference movement parts representative of the movement by the player 12.

FIG. 3 illustrates one example embodiment of the processing step 26.

According to the example of FIG. 3, the processing step 26 includes a provision sub-step 32, an obtainment sub-step 34 and a computation sub-step 36.

In the provision sub-step 32, a set of characteristic parameters is provided relative to the movement to be identified during the chosen computing time interval. The provision sub-step 32 is for example implemented by the device 16.

According to one example, the sub-step 32 comprises a sub-step for measuring characteristic parameters and a sub-step for sending measured characteristic parameters to the computer. In such an embodiment, the measured characteristic parameters are the provided characteristic parameters.

In the transmission sub-step, the set of parameters is sent to the computer 14, and in particular to the memory unit 18, which stores the set of parameters.

At the end of the provision sub-step 32, in the memory 18 unit, a set of characteristic parameters is stored relative to the movement to be identified during the chosen computing time interval.

According to one embodiment, the set of characteristic parameters relative to the movement of the player 12 during the chosen computing time interval is the position of n joints of the player 12, n being a strictly positive integer. Advantageously, the integer n is greater than or equal to 10, preferably greater than or equal to 20. Advantageously, the number of parameters is greater than or equal to 6, preferably greater than or equal to 40, preferably greater than or equal to 60.

According to one preferred embodiment, the provision sub-step 32 is implemented in real time. This means that a constant stream of information reaches the computer 14, which processes the information of the real-time stream. Such an embodiment makes it possible to accelerate the identification of the movement to be identified.

In the obtainment sub-step 34, the input parameters are the set of provided characteristic parameters. The obtainment sub-step 34 is thus a step for preparing data seeking to facilitate the subsequent computations involving that same data. In other words, the obtainment sub-step 34 can be mathematically represented in the form of the application of a transform to the input parameters.

Such a transform is able to convert the provided parameters into input parameters.

In the general case, the number of input parameters has no connection to the number of provided parameters. In particular, according to one preferred embodiment, the number of input parameters is different from the number of provided parameters.

Advantageously, the number of input parameters is strictly less than the number of provided parameters to reduce the dimensionality of the problem to be addressed.

Preferably, the transform is chosen so that the random variables whereof the realizations are the respective values of each of the input parameters are independent of one another.

Preferably, the transform is also chosen so that the random variables whereof the realizations are the respective values of each of the input parameters are independent of the other variables not related to the movement to be identified. As an example, the time (more specifically, the time is related to the movement, but not to the trajectory), the morphology of the person or the brightness conditions are variables not related to the movement to be identified.

According to the embodiments, the obtainment sub-step 34 comprises different sub-steps. FIG. 4 illustrates an example of a series of sub-steps, with the understanding that each sub-step is optional and that any combination of the described sub-steps can also be considered to carry out the obtainment sub-step 34.

In the example of FIG. 4, the sub-step 34 includes a sub-step 40 for sequencing the provided characteristic parameters in a predefined order.

The sequencing sub-step 40 makes it possible, as an illustration, to sequence the parameters in a vectorial form.

Optionally, the sequencing sub-step 40 includes a step for gathering the provided parameters whose meaning or computation is related.

The sub-step 34 next includes a sub-step 42 for interpolating all of the characteristic parameters provided over the chosen computation time interval to obtain continuous interpolated input parameters.

The interpolation for example uses a linear piecewise function between each successive parameter.

Alternatively, a polynomial or spline function interpolation can be considered. In the mathematical field of numerical analysis, a spline is a function defined in a piecewise manner by polynomials. The corresponding French term is “cerce”, but the English term is typically used.

Alternatively, the sub-step 34 comprises a sub-step for computing the central trend of all of the characteristic parameters provided over the chosen computation time interval to obtain continuous input parameters.

The obtainment sub-step 34 next comprises a sub-step 44 for projecting the provided parameters on an orthogonal base. Preferably, the orthogonal base is chosen to reduce the number of interpolated parameters. Advantageously, the orthogonal base is obtained by implementing a primary component analysis applied to all of the points in time of the movements of the acquired knowledge base. To that end, a matrix is built including as many columns as there are characteristic parameters and as many rows as the sum of the number of points in time of the movements of the knowledge base. The variance-covariance matrix is next computed. The primary components analysis is next applied on this variance-covariance matrix. The primary components analysis makes it possible to determine at eigenvectors each associated with an eigenvalue. Only a reduced certain number of eigenvectors associated with the largest eigenvalues will be retained. These form said orthogonal base.

The obtainment sub-step 34 also includes a sub-step 46 for normalizing the provided parameters to the size of the player 12.

To that end, for example, the distance between each pair of joints, preferably adjacent, is computed at a predefined moment for each pair of joints. Such a distance is called normalization length. The normalization length is for example estimated by using an averaging over time on the positions of joints for two separate acquisitions of parameters (as long as the two acquisitions are valid). This is only true for the times during which both joints are valid. Furthermore, it is assumed that these times are close enough to ensure that at each of these moments, the same human operator is imaged.

In this case, instead of taking into account the position of a joint as input parameter, only the ratio between the difference in distance between each pair of adjacent joints and the normalization length is taken into account.

“Adjacent joints”, depending on the case, refers to two successive joints, two joints separated by a third joint or two ends of a same limb. The case of two joints separated by a third joint is in particular considered when the parameters related to the third joint are not valid or are not accessible (for example, given the position of the player 12, the measurement of the parameters related to the third joint is impossible because the third joint is hidden).

According to one alternative, the system 10 is capable of determining the normalization length by interaction with the player 12. For example, the system 10 asks the player 12 for his height. The height of the player 12 then makes it possible to obtain the normalization length, for example by using a proportionality law. The limbs of a tall person are usually larger than the limbs of a shorter person.

The sub-step 34 also includes a sub-step 48 for the spatial or temporal derivation or integration of at least one parameter of the set of characteristic parameters provided to obtain at least one derived and integrated parameter, respectively, of the input parameters. Preferably, said at least one derived and/or integrated parameter is independent of the speed of the movement to be identified. Preferably, the sub-step 48 performs a derivation and an integration over space and not over time. According to one alternative, the sub-step 48 is a derivation sub-step only. This means that no integration of at least one of the parameters of the set of provided characteristic parameters is done. The sub-step 48 is then a sub-step for the derivation of at least one parameter of the set of characteristic parameters provided to obtain at least one derived parameter of the input parameters. According to another alternative, the sub-step 48 is an integration sub-step only. This means that no derivation of at least one of the parameters of the set of provided characteristic parameters is done. The sub-step 48 is then a sub-step for the integration of at least one parameter of the set of characteristic parameters provided to obtain at least one integrated parameter of the input parameters.

More generally, the sub-step 48 is a step for computing additional parameters. The spatial derivation and the spatial integration are two particular examples of functions that can be used in the sub-step 48. The tangent to the spatial curve connecting the interpolated parameters is advantageously computed in sub-step 48. The tangent to the spatial curve makes it possible to distinguish between two identical postures for the device 16, but corresponding to two different movements. Such a scenario in practice occurs due to the relatively significant acquisition noise for the device 16.

Similarly, the curved abscissa is also computed in sub-step 48. The use of these two parameters (tangent and curved abscissa) makes it possible to simplify the computations done in the continuation of the identification method relative to the use of the derivation and temporal integration. The two parameters in fact have the advantage of being independent of the time and therefore the performance speed of the movement.

The obtainment sub-step 34 also comprises a sub-step 50 for checking the validity of the provided characteristic parameters.

The sub-step 50 for checking the validity of the provided characteristic parameters makes it possible to take into account the missing information for certain parameters (for example, in the case of a hidden joint). The checking sub-step 50 is for example implemented by using information sent to the device 16. The device 16 then provides information relative to the validity of the provided characteristic parameters.

According to another embodiment, consistency checks are done between the provided characteristic parameters making it possible to determine the provided characteristic parameters that are inconsistent with the other provided parameters. The inconsistent parameters are considered to be invalid and therefore dismissed from the continuation of the implementation of the identification method. According to another embodiment, if one or several characteristic parameters are declared invalid, the invalid parameters are then recomputed by interpolation.

The interpolation for example uses a linear piecewise function between each successive parameter. Alternatively, a polynomial or spline function interpolation can be considered.

At the end of the obtainment sub-step 34, a set of input parameters is therefore obtained.

According to one particularly advantageous embodiment, the set of input parameters during the chosen computing time interval comprises, for each joint of the player 12, the differences in position between two adjacent joints of the player 12, the spatial derivatives of each of the differences and/or the spatial integral of each of the difference and the absolute movement of a point of the skeleton, normalized by a function of the length of certain limbs.

Optionally, the obtainment sub-step 34 includes one or several reference change steps.

For example, a reference change taking account of the difference between the vertical position of the player 12 and the normal to the floor on an axis makes it possible to do away with height and vertical orientation problems of the device 16 relative to the floor and the player 12. In other words, such a reference change makes it possible to control the orientation and position of the device 16. Advantageously, such a reference change takes account of the position of the floor provided by the device 16. According to another example, the coordinates of the parameters are expressed in spherical coordinates instead of Cartesian coordinates. A transition from Cartesian coordinates to spherical coordinates makes it possible, in the case of differences between immediately adjacent joints normalized by the length of the limb separating them, to reduce the number of parameters and eliminate the dependency between the parameters of a same joint. Indeed, when the vector representing a pair of immediately adjacent joints is normalized, this creates a dependency between the three coordinates of the vector. These three coordinates are then advantageously replaced by two Euler angles. According to another embodiment, the obtainment sub-step 34 includes a step for introducing a delay. This makes it possible to improve the estimate of the value of the parameters, and in particular spatial derivatives of the parameters. More specifically, either the spatial derivative is computed between two points in time that are not immediately consecutive, or the acquired points in time are replaced by averages of successive points in time.

Optionally, the obtainment sub-step 34 comprises taking account of the uncertainty of each provided parameter. Typically, such taking into account uses a statistical analysis of the noise of the parameters. For example, instead of taking a measured value as the value for a parameter, it will be considered that the value of the parameter is comprised in a value interval related to the measured value and the noise significance. As an example, for a Gaussian noise having a variance, the squared difference between two characteristic parameters is divided by the variance of the Gaussian noise (assuming that the parameters are independent of one another in terms of statistical uncertainty).

In the computation sub-step 36, a point is computed. The computation sub-step 36 is implemented by the processor 20.

The computed point fulfills a dual condition. On the one hand, the computed point belongs to a reference kinematic. On the other hand, the computed point makes a deviation function between the input parameters and the kinematic reference points extremal.

For example, the deviation function is the expression of the distance in the multidimensional space of the input parameters.

Preferably, the distance is a non-Euclidean distance to take account of the dispersion of the reference movements around the corresponding reference kinematics.

Advantageously, the deviation function comprises a weighting of the input parameters depending on one or several elements of the group made up of the reliability of the parameter, the nature of the parameter, the parameter itself and the uncertainty of the measurement of the parameter.

The reliability of the parameter has for example been determined during the implementation of the sub-step 50 for checking the validity of the provided characteristic parameters.

Preferably, the deviation function also takes account of a penalty of the least probable kinematic points. Typically, the performance of a movement in the opposite direction or a point that is spatially very far from the preceding points is less likely than a point in the continuation of the started movement.

In this case, the determination step 30 takes into account the points computed upon each iteration of the processing step 26.

Advantageously, the determination step 30 is carried out by minimizing a cost function, also called score function.

Once the movement by the player 12 has been identified, the intention of the player 12 is associated with one or several reference kinematics, i.e., at least one reference movement.

According to one alternative, the intention of the player 12 is associated with a reference kinematic part.

It is then possible to define the reactions of any artificial intelligence in human terms. For example, if the identified reference movements are fencing movements, the identified movement is labeled “tierce hit”. The fencing treaties then indicate how one should react to such an attack: by a “tierce parry”, by a “sixte parry”, by a “high seconde parry” or by a “protective parry of the armed arm”. Thus, the identification method makes it possible not only to simplify the design of the artificial intelligence, but also to make such a design more generic and more effective.

The identification method according to the first embodiment makes it possible to identify the movement on the fly. This allows an interaction with the player 12 when the interaction is more complex than simply pressing a button on the controller corresponding to a traditional video game experience. The on-the-fly recognition also makes it possible to detect changes in the intention of the player 12 immediately. In the case of fencing, if the player 12 initially performs a “seconde hit”, the artificial intelligence of the player's 12 opponent performs the appropriate parry (a “seconde parry” or an “octave parry”). If the player 12, performing a feint, then changes line of attack to perform a “tierce hit”, such a change in movement is detected immediately, allowing the artificial intelligence to go from the movement that the artificial intelligence was performing (a “seconde parry”, for example), to a “high seconde parry”, thereby allowing the artificial intelligence to parry the new attack by the player 12 with the most appropriate movement taking account not only of the attack by the player 12, but also of the previous movement that the artificial intelligence was beginning to perform. The identification method according to the first embodiment also allows the identification of a reference movement part and makes it possible to obtain information on the location of the part performed on the reference movement. For example, it is possible to determine that the identified movement part corresponds to what is done between the middle of the reference movement and three quarters of the implementation of the reference movement. This allows the artificial intelligence controlling the opponent of the player 12 to react at the right moment. An excessively early parry of the movement done by the player 12 is in fact easily bypassed by a feint. Conversely, an excessively late parry of the movement done by the player 12 only partially protects the opponent of the player 12, or provides no protection at all. The identification method according to the first embodiment is applicable independently of the number of reference movements. As a result, flaws related to an excessively low number of reference movements are avoided. For example, it is possible to achieve maximum simplification, for example a hit from above or toward the right as in the case of a game on the Wii console, to which the two corresponding parries and the en garde position are added. In this extremely simple case, (2+2+1)²=25 different movements are taken into account. It is also possible to ignore certain movements, for example by only authorizing movements to or from the guard. Only 4×2=8 different movements then remain. In case of transition from a parry to an attack or vice versa, however, the chances of correct identification of the movement are greatly decreased. The method has been validated on 60 different reference kinematics. The identification method according to the first embodiment makes it possible to take account of all of the parameters acquired by the device 16 at the same pace that the device 16 acquires the parameters. Typically, as an illustration, the identification method according to the first embodiment is capable of taking account of 60 movement parameters acquired every 1/30^{th} of a second or is capable of taking account of six movement parameters acquired every 1/60^{th} of a second. The identification method according to the first embodiment is also capable of detecting movement changes. Such a detection capacity is implemented in two different cases: when going from a first finished reference movement to a second beginning movement and when going from a first reference movement in progress to another reference movement in progress. The first case guarantees fluidity in the identification of the movement, the player 12 naturally going from one completed reference movement to another reference movement, without needing to pause between two successive movements. The second case corresponds to performing feints, which occurs frequently in fencing. The identification method according to the first embodiment makes it possible to identify the movement in less than thirty seconds on a single (performance) thread of a game console. This makes it possible to reserve the other (performance) threads of the game consoles for graphics and sound. The implementation of the identification method according to the first embodiment is therefore transparent for the player 12. The identification method according to the first embodiment also makes it possible to detect the intention of the player 12. The identification method according to the first embodiment ensures a refined understanding of the movement to be identified as the movement by the player 12 takes place. The more time that passes, or more accurately, the further the player 12 progresses in performing his movement, the better the artificial intelligence is able to correctly analyze the movement by the player 12.

This corresponds exactly to a simulation of reality: a fencer determines, with increasing certainty, the movement performed by his enemy as his enemy performs it. The identification method according to the first embodiment is able to segment the movement automatically with no indication of the beginning or end of a movement. The identification method according to the first embodiment takes account of the fact that certain characteristic parameters of the movement to be identified by the device 16 are more or less valid. This makes it possible to guarantee a convergence of the identification method according to the first embodiment even when certain provided characteristic parameters are abnormal. Furthermore, the identification method according to the first embodiment makes it possible to manage the insufficiencies of the device 16. For example, when information is missing regarding the orientation of the wrist or the position of the blade, the identification method according to the first embodiment nevertheless makes it possible to identify reference movements by using the position of the joints of the body of the player 12. According to another example, without knowing the posture of the body, the identification method according to the first embodiment is also capable of determining the movement performed by the player 12 only with the position and orientation of the blade. The identification method according to the first embodiment also has the advantage of being independent of time. Thus, it is of little importance whether the movements of the player 12 are done very quickly, very slowly, quickly at the beginning and slowly at the end or the other way around. Such variability in the performance speed has no impact on the identification, and thus on the reaction possibilities of the artificial intelligence. The identification method according to the first embodiment also has the advantage of being independent of the morphology of the player 12. The overall differences in size or proportions, in particular relative to the width of the shoulders or the length of the arms of the player 12, are taken into account. The identification method according to the first embodiment, in particular combined with the method according to the fifth embodiment, also makes it possible to obtain a computation time per temporal frame on a single (performance) thread of less than 1/30^{th} of a second for about 1000 different reference kinematics in the knowledge base. This makes it possible to then include, in the same temporal frame, an artificial intelligence producing a response by an opponent or allied with the character of the player 12 from recognition information and information accessible to the artificial intelligence. The identification method according to the first embodiment makes it possible to obtain a better identification rate than the recognition rate obtained with the methods of the state of the art. Typically, in the case of fencing, the identification rate of a point in time of a movement is strictly greater than 85%. Such precision is only achieved with the methods of the state of the art at the end of the movement, with the information of all of the points in time of the movement. Furthermore, this identification rate is obtained for 60 reference kinematics, versus a maximum of about ten for the methods of the state of the art. The identification method according to the first embodiment also has the advantage of guaranteeing a maximum identification rate in the time interval during which the artificial intelligence has to make a response decision. According to one preferred embodiment, the identification method according to the first embodiment also makes it possible to predict the likeliest future postures of the player 12 and/or the positions of the blade of the player 12. The artificial intelligence is then able to make decisions taking account of the predicted postures and/or positions. A decision for example consists of determining the most timely action among an attack, a counter-attack or a parry. According to the most highly evolved operating modes, the decision takes account of a specific behavior to simulate a human opponent. For example, to simulate an impatient human being, a counter-attack will be favored relative to a parry.

Optionally, the identification method according to the first embodiment is able to provide an indicator of the performed movement. Such information makes it possible to obtain a performance indicator of the movement performed by the player 12. For example, the gravity of the inflicted injury is thus determined in case of an attack that is not parried or the imbalance of the opponent in case of successful parry with excellent quality. The quality indicator for the movement also makes it possible to teach the player 12 to perform the reference movements correctly, which may correspond to a technique used outside any recognition framework. For example, in a fencing game, this makes it possible to improve one's fencing technique. The movement quality indicator also makes it possible to facilitate the identification of later movements by the same player 12.

Advantageously, the identification method according to the first embodiment includes a step for filtering the movements by the player 12. This for example makes it possible to favor viewing or avoid taking account of abnormal positions of certain joints. Preferably, the identification method according to the first embodiment includes a step for reconstructing the identified movement(s) performed by the player 12. This makes it possible to facilitate the learning by the artificial intelligence of the specificities of the player 12, in particular the choices, strengths and past errors. According to one preferred embodiment, the artificial intelligence is able to provide the player 12 with advice to improve his practice.

In summary, according to one embodiment combining several of the preceding options, at the end of implementation of the identification method according to the first embodiment, a plurality of information is accessible to the computer, and thus to the artificial intelligence: the reference movement part(s) most resembling the movement to be identified, the advancement in the movement to be identified relative to a complete performance of the reference movement, an estimate of the quality of the movement performed relative to the reference movement and the quality of the identification done by the identification method.

According to another embodiment of the identification method according to the first embodiment, each iteration of the processing step 26 also includes a sub-step for choosing the computing time interval for the following iteration. According to one alternative, the processing step 26 does not include an obtainment sub-step 34. In this case, the input parameters are the provided characteristic parameters. According to still another embodiment, each iteration of the processing step 26 further includes a sub-step for selecting the reference kinematic during the chosen computation time interval by minimizing a cost function taking into account the points computed in the previous iterations of the processing step 26. Preferably, the cost function used in the sub-step for selecting the reference kinematic is the deviation function used in the computation sub-step 36 during the same iteration. Optionally, each iteration of the processing step 26 further includes a sub-step for detecting a change of reference kinematic if the reference kinematic selected in the selection sub-step is different from the reference kinematic selected in the previous iteration of the processing step 26.

According to another embodiment, the reaction by the artificial intelligence to the movements by the player 12 depends on the difficulty level chosen by the video game player 12 to run the video game.

To illustrate the performance that the implementation of the method for identifying a movement of the player 12 according to the first embodiment makes it possible to achieve, a concrete example implementation of such an identification method according to the first embodiment is outlined, emphasizing the obtained numerical results. The following table gives the percentage of points correctly recognized by reference kinematics by implementing the identification method according to the first embodiment (second column). The following table also provides access to the percentage of points for which the reaction by the artificial intelligence resulting therefrom is most appropriate.

| | Recognition | Appropriate reaction |
|---|---|---|
| | percentage | percentage by the |
| Reference kinematics | (%) | artificial intelligence (%) |
| Manchette hit | 79.9 | 82.9 |
| Quarte hit 1 to the cheek | 89.0 | 92.2 |
| Quarte hit 1 to the leg | 90.3 | 95.4 |
| Tierce hit 2 to the cheek | 91.4 | 93.3 |
| Tierce hit 2 to the leg | 84.6 | 90.0 |
| Septime hit 3 to the cheek | 82.5 | 88.9 |
| Septime hit 3 to the leg | 79.1 | 89.2 |
| Seconde hit 4 to the cheek | 85.1 | 93.3 |
| Seconde hit 4 to the leg | 88.4 | 92.6 |
| Hit 5 to the cheek | 85.3 | 88.4 |
| Hit 5 to the side | 84.6 | 88.1 |
| Hit 6 to the cheek | 90.5 | 93.6 |
| Hit 6 to the side | 89.0 | 92.8 |
| Quinte hit 7 to the head | 90.6 | 92.3 |
| Prime hit 8 to the crotch area | 89.0 | 94.4 |
| High octave parry | 77.3 | 82.4 |
| High prime parry | 78.6 | 89.5 |
| High quarte parry | 81.9 | 87.7 |
| High seconde parry | 88.5 | 93.2 |
| High tierce parry | 68.2 | 84.3 |
| Horizontal quarte parry | 93.1 | 95.8 |
| Low prime parry | 89.2 | 92.4 |
| Low quarte parry | 88.0 | 93.4 |
| Low tierce parry | 60.1 | 63.6 |
| Octave parry | 78.0 | 84.8 |
| Prime parry | 75.3 | 84.4 |
| Quarte parry | 82.6 | 84.3 |
| Saint George parry | 81.5 | 88.3 |
| Seconde parry | 93.3 | 94.7 |
| Septime parry | 90.7 | 95.3 |
| Sixte parry | 90.9 | 94.4 |
| Tierce parry | 70.5 | 95.8 |
| En garde attack return | 8.6 | 37.8 |
| En garde parry return | 71.2 | 76.9 |

Upon studying the table, it appears that the percentage of points in time correctly recognized is 87.3% and the percentage of points in time leading to a correct response from an artificial intelligence for a fencing game (which for example does not differ in its response to a tierce parry and a sixte parry), is 92%. It should, however, be specified that for the points incorrectly recognized or for which the response from the artificial intelligence is not the most appropriate, this has no impact on the fencing video game inasmuch as certain phases of the fencing game, such as the guard, do not involve a specific response and the decision by the artificial intelligence to make a movement comprises several moments and not just one.

Method for Identifying a Movement by a Player 12 within the Knowledge Base by Minimizing the Energy of Paths Built from Movement Points of the Knowledge Base

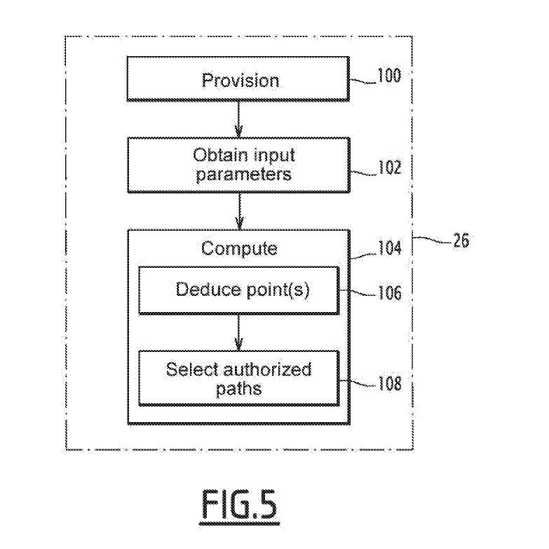

A second embodiment of the identification method is now described in reference to FIGS. 2 and 5.

The architecture of the flowchart of FIG. 2 is retained for the second embodiment of the identification method.

As a result, as for the first embodiment of the identification method, the identification method according to the second embodiment also comprises a step 22 for choosing a computation time interval, a step 24 for selecting a starting point, a processing step 26, a step 28 for recognizing the end of the movement by the player 12 and a step 30 for determining the reference movement(s) or the series of reference movement parts representative of the movement by the player 12. The step 22 for choosing a computation time interval and the step 28 for recognizing the end of the movement by the player 12 are identical to the preceding description. The associated features are not repeated for the description of the identification method according to the second embodiment, but also apply.

Only the differences relative to the step 24 for selecting a starting point, the processing step 26 and the step 30 for determining the reference movement(s) or the series of reference movement parts representative of the movement by the player 12 are specified below in reference to the flowchart of FIG. 5. The identical elements are not repeated for the description of the identification method according to the second embodiment.

The step 24 for selecting a starting point of the identification method according to the second embodiment is, according to one embodiment, implemented in the same way as the step 24 for selecting a starting point of the identification method according to the first embodiment.

However, preferably, in the step 24 for selecting a starting point, it is not a starting point that is chosen, but a set of starting points fulfilling a criterion. The criterion is for example twofold: belonging to a reference kinematic and having a distance from a reference point smaller than or equal to a predefined threshold.

Such a manner of carrying out the step 24 for selecting a starting point makes it possible to take advantage of the fact that the selection of the paths in the framework of the identification method according to the second embodiment is automatic.

According to the example of FIG. 5, the processing step 26 includes a provision sub-step 100, an obtainment sub-step 102 and a computation sub-step 104.

The provision sub-step 100 and the obtainment sub-step 102 are respectively identical to the provision sub-step 32 and the obtainment sub-step 34 previously described in reference to FIG. 3. More specifically, this means that all of the remarks to describe the provision sub-step 32 and the obtainment sub-step 34 also apply to the provision sub-step 100 and the obtainment sub-step 102, respectively. As a result, the provision sub-steps 100 and the obtainment sub-step 102 are not described below.

The computation sub-step 104 seeks to compute the paths, a path being a series of points. Said points are representative of or associated with a reference kinematic. As a reminder, the reference kinematic may be continuous or discrete. Preferably, said points each belong to a reference kinematic.

The computation sub-step 104 comprises a sub-step 106 for deducing, according to a first rule, the following point(s) of each path, to obtain a set of authorized paths, each deduced point belonging to a reference kinematic and depending on the input parameters.

As an example, according to the first rule, a single point is deduced for a path whose energy is strictly lower than the energies of each other series of points computed in the preceding iteration of the processing step 26.

According to another example, according to the first rule, for the non-minimal energy paths, the deduced points belong to the same reference kinematic as the point obtained for this path in the preceding iteration.

The point deduced in such a case in the deducing sub-step 106 is then the following point of the reference kinematics to which the point obtained in the preceding iteration of the processing step 26 belongs for the considered minimum energy path. Preferably, the energy of a series of points is defined as the sum over the points of the paths of a deviation function between the point of the path and the corresponding point of the movement currently performed by the player 12. This deviation function accounts for the position of the points, but also the tangents to the movement and the lengths traveled. According to one alternative, the energy of a series of points is defined as a decreasing monotonous function of the a posteriori probability of association of the path with the movement performed by the player 12. This a priori probability of association is preferably the product of the points of the path of the association probabilities of this point of the path with the corresponding point of the movement of the player 12.

At the end of the deducing sub-step 106, the following point(s) of each path have been deduced. The set of paths following the paths already computed and passing through the deduced points forms the authorized paths.

The computing sub-step 104 also comprises a sub-step 108 for selecting, among the authorized paths, a set of optimal paths, each for a set of different paths according to the second rule.

According to a first embodiment, between all of the following points of a same path belonging to a same reference kinematic, only the point for which the energy of the path is minimal is retained.

According to a second embodiment optionally used in combination with the first embodiment, between all of the paths ending with the same point, only the path with minimum energy is retained.

According to a third embodiment optionally used in combination with one or several of the preceding embodiments, between all of the paths ending with a point belonging to the same reference kinematic, only the path with minimum energy is retained. Preferably, several paths are retained: at least, per reference kinematic, one path whose last point belongs to that reference kinematic. As an example, according to the second rule, if a point deduced at the end of the deducing sub-step 106 belongs to two different paths, only the path whose series of points has a minimal energy is selected. This makes it possible to reduce the number of authorized paths and thus to accelerate the computation.

Preferably, the definition of the minimum energy used in the selection sub-step 108 is the same as the definition of the minimal energy used during the implementation of the deducing sub-step 106.

According to one embodiment, the determination step 30 of the identification method according to the second embodiment takes into account the paths computed in the last iteration of the processing step 26. Advantageously, the determination step 30 is carried out by minimizing a cost function.

According to one embodiment, the determined path is the path having a minimal energy.

The identification method according to the second embodiment makes it possible to identify the movement on the fly. This allows an interaction with the player 12 when the interaction is more complex than simply pressing a button on the controller corresponding to a traditional video game experience. The on-the-fly recognition also makes it possible to detect changes in the intention of the player 12 immediately. In the case of fencing, if the player 12 initially performs a “seconde hit”, the artificial intelligence of the player's 12 opponent performs the appropriate parry (a “seconde parry” or an “octave parry”). If the player 12, performing a feint, then changes line of attack to perform a “tierce hit”, such a change in movement is detected immediately, allowing the artificial intelligence to go from the movement that the artificial intelligence was performing (a “seconde parry”, for example), to a “high seconde parry”, thereby allowing the artificial intelligence to parry the new attack by the player 12 with the most appropriate movement taking account not only of the attack by the player 12, but also of the previous movement that the artificial intelligence was beginning to perform. The identification method according to the second embodiment also allows the identification of a reference movement part and makes it possible to obtain information on the location of the part performed on the reference movement. For example, it is possible to determine that the identified movement part corresponds to what is done between the middle of the reference movement and three quarters of the implementation of the reference movement. This allows the artificial intelligence controlling the opponent of the player 12 to react at the right moment. An excessively early parry of the movement done by the player 12 is in fact easily bypassed by a feint. Conversely, an excessively late parry of the movement done by the player 12 only partially protects the opponent of the player 12, or provides no protection at all. The identification method according to the second embodiment is applicable independently of the number of reference movements. As a result, flaws related to an excessively low number of reference movements are avoided. For example, it is possible to achieve maximum simplification, for example a hit from above or toward the right as in the case of a game on the Wii console, to which the two corresponding parries and the en garde position are added. In this extremely simple case, (2+2+1)²=25 different movements are taken into account. It is also possible to ignore certain movements, for example by only authorizing movements to or from the guard. Only 4×2=8 different movements then remain. In case of transition from a parry to an attack or vice versa, however, the chances of correct identification of the movement are greatly decreased. The method has been validated on 60 different reference kinematics. The identification method according to the second embodiment makes it possible to take account of all of the parameters acquired by the device 16 at the same pace that the device 16 acquires the parameters. Typically, as an illustration, the identification method according to the second embodiment is capable of taking account of 60 movement parameters acquired every 1/30^{th} of a second or is capable of taking account of six movement parameters acquired every 1/60^{th} of a second. The identification method according to the second embodiment is also capable of detecting movement changes. Such a detection capacity is implemented in two different cases: when going from a first finished reference movement to a second beginning movement and when going from a first reference movement in progress to another reference movement in progress. The first case guarantees fluidity in the identification of the movement, the player 12 naturally going from one completed reference movement to another reference movement, without needing to pause between two successive movements. The second case corresponds to performing feints, which occurs frequently in fencing. The identification method according to the second embodiment makes it possible to identify the movement in less than thirty seconds on a single (performance) thread of a game console. This makes it possible to reserve the other (performance) threads of the game consoles for graphics and sound. The implementation of the identification method according to the second embodiment is therefore transparent for the player 12. The identification method according to the second embodiment also makes it possible to detect the intention of the player 12. The identification method according to the second embodiment ensures a refined understanding of the movement to be identified as the movement by the player 12 takes place. The more time that passes, or more accurately, the further the player 12 progresses in performing his movement, the better the artificial intelligence is able to correctly analyze the movement by the player 12. This corresponds exactly to a simulation of reality: a fencer determines, with increasing certainty, the movement performed by his enemy as his enemy performs it. The identification method according to the second embodiment is able to segment the movement automatically with no indication of the beginning or end of a movement. The identification method according to the second embodiment takes account of the fact that certain characteristic parameters of the movement to be identified by the device 16 are more or less valid. This makes it possible to guarantee a convergence of the identification method even when certain provided characteristic parameters are abnormal. Furthermore, the identification method according to the second embodiment makes it possible to manage the insufficiencies of the device 16. For example, when information is missing regarding the orientation of the wrist or the position of the blade, the identification method according to the second embodiment nevertheless makes it possible to identify reference movements by using the position of the joints of the body of the player 12. According to another example, without knowing the posture of the body, the identification method according to the second embodiment is also capable of determining the movement performed by the player 12 only with the position and orientation of the blade. The identification method according to the second embodiment also has the advantage of being independent of time. Thus, it is of little importance whether the movements of the player 12 are done very quickly, very slowly, quickly at the beginning and slowly at the end or the other way around. Such variability in the performance speed has no impact on the identification, and thus on the reaction possibilities of the artificial intelligence. The identification method according to the second embodiment also has the advantage of being independent of the morphology of the player 12. The overall differences in size or proportions, in particular relative to the width of the shoulders or the length of the arms of the player 12, are taken into account. The identification method according to the second embodiment, in particular combined with the method according to the fifth embodiment, also makes it possible to obtain a computation time per temporal frame on a single (performance) thread of less than 1/30^{th} of a second for about 1000 different reference movements in the knowledge base. This makes it possible to then include, in the same temporal frame, an artificial intelligence producing a response by an opponent or allied with the character of the player 12 from recognition information and information accessible to the artificial intelligence. The identification method according to the second embodiment makes it possible to obtain a better identification rate than the recognition rate obtained with the methods of the state of the art. Typically, in the case of fencing, the identification rate of a point in time of a movement is strictly greater than 85%. Such precision is only achieved with the methods of the state of the art at the end of the movement, with the information of all of the points in time of the movement. Furthermore, this identification rate is obtained for 60 reference kinematics, versus a maximum of about ten for the methods of the state of the art.

The identification method according to the first embodiment also has the advantage of guaranteeing a maximum identification rate in the time interval during which the artificial intelligence has to make a response decision.

According to one preferred embodiment, the identification method according to the second embodiment also makes it possible to predict the likeliest future postures of the player 12 and/or the positions of the blade of the player 12. The artificial intelligence is then able to make decisions taking account of the predicted postures and/or positions. A decision for example consists of determining the most timely action among an attack, a counter-attack or a parry. According to the most highly evolved operating modes, the decision takes account of a specific behavior to simulate a human opponent. For example, to simulate an impatient human being, a counter-attack will be favored relative to a parry.

Optionally, the identification method according to the second embodiment is able to provide an indicator of the performed movement. Such information makes it possible to obtain a performance indicator of the movement performed by the player 12. For example, the gravity of the inflicted injury is thus determined in case of an attack that is not parried or the imbalance of the opponent in case of successful parry with excellent quality. The quality indicator for the movement also makes it possible to teach the player 12 to perform the reference movements correctly, which may correspond to a technique used outside any recognition framework. For example, in a fencing game, this makes it possible to improve one's fencing technique. The movement quality indicator also makes it possible to facilitate the identification of later movements by the same player 12.

Advantageously, the identification method according to the second embodiment includes a step for filtering the movements by the player 12. This for example makes it possible to favor viewing or avoid taking account of abnormal positions of certain joints.

Preferably, the identification method according to the second embodiment includes a step for reconstructing the identified movement(s) performed by the player 12. This makes it possible to facilitate the learning by the artificial intelligence of the specificities of the player 12, in particular the choices, strengths and past errors. According to one preferred embodiment, the artificial intelligence is able to provide the player 12 with advice to improve his practice.

According to another embodiment of the identification method according to the second embodiment, each iteration of the processing step 26 also includes a sub-step for choosing the computing time interval for the following iteration of the processing step 26. According to one alternative, the processing step 26 does not include an obtainment sub-step 102. In this case, the input parameters are the provided characteristic parameters. According to still another embodiment, each iteration of the processing step 26 further includes a sub-step for selecting the reference kinematic during the chosen computation time interval by determining the path minimizing a cost function. According to one embodiment, the selected reference kinematic is the reference kinematic of the point of the path having a minimal energy during the chosen computation time interval.

Optionally, each iteration of the processing step 26 further includes a sub-step for detecting a change of reference kinematic if the reference kinematic determined in the determination sub-step is different from the reference kinematic determined in the previous iteration of the processing step 26.

According to another embodiment, the reaction by the artificial intelligence to the movements by the player 12 depends on the difficulty level chosen by the player 12 to run the video game.

To illustrate the performance that the implementation of the method for identifying a movement of the player 12 according to the second embodiment makes it possible to achieve, a concrete example implementation of such an identification method according to the second embodiment is outlined, emphasizing the obtained numerical results.

The following table gives the percentage of points correctly recognized by reference kinematics by implementing the identification method according to the first embodiment (second column). The following table also provides access to the percentage of points for which the reaction by the artificial intelligence resulting therefrom is most appropriate.

| | Recognition | Appropriate reaction |
|---|---|---|
| | percentage | percentage by the |
| Reference kinematics | (%) | artificial intelligence (%) |
| Manchette hit | 86.2 | 87.6 |
| Quarte hit 1 to the cheek | 95.6 | 96.9 |
| Quarte hit 1 to the leg | 97.3 | 98.8 |
| Tierce hit 2 to the cheek | 97.3 | 98.9 |
| Tierce hit 2 to the leg | 91.9 | 94.9 |
| Septime hit 3 to the cheek | 89.2 | 91.2 |
| Septime hit 3 to the leg | 85.3 | 93.2 |
| Seconde hit 4 to the cheek | 91.2 | 97.6 |
| Seconde hit 4 to the leg | 93.7 | 96.7 |
| Hit 5 to the cheek | 89.9 | 91.8 |
| Hit 5 to the side | 88.6 | 94 |
| Hit 6 to the cheek | 88.6 | 96.7 |
| Hit 6 to the side | 96 | 97.8 |
| Quinte hit 7 to the head | 96.8 | 98.2 |
| Prime hit 8 to the crotch area | 92.5 | 96.7 |
| High octave parry | 81.4 | 86.7 |
| High prime parry | 84.3 | 91.4 |
| High quarte parry | 86.7 | 89.1 |
| High seconde parry | 93.3 | 98.0 |
| High tierce parry | 75.1 | 87.4 |
| Horizontal quarte parry | 99.7 | 99.9 |
| Low prime parry | 94.3 | 97.6 |
| Low quarte parry | 91.7 | 97.2 |
| Low tierce parry | 66.6 | 66.6 |
| Octave parry | 84.7 | 89.6 |
| Prime parry | 80.7 | 87.9 |
| Quarte parry | 87.6 | 90.1 |
| Saint George parry | 88.1 | 91.7 |
| Seconde parry | 98.2 | 98.2 |
| Septime parry | 99.1 | 99.1 |
| Sixte parry | 97.2 | 98 |
| Tierce parry | 76 | 78.5 |
| En garde attack return | 7.8 to 100 | 40.4 to 100 |
| En garde parry return | 74.8 to 100 | 81.2 to 100 |

Upon studying the table, it appears that the percentage of points in time correctly recognized is 93% and the percentage of points in time leading to a correct response from an artificial intelligence for a fencing game (which for example does not differ in its response to a tierce parry and a sixte parry), is 95.75%. It should, however, be specified that for the points incorrectly recognized or for which the response from the artificial intelligence is not the most appropriate, this has no impact on the fencing video game inasmuch as certain phases of the fencing game, such as the guard, do not involve a specific response and the decision by the artificial intelligence to make a movement comprises several moments and not just one.

Method for Identifying a Movement by a Player 12 by Using Quantified Recursive Bayesian Filtering

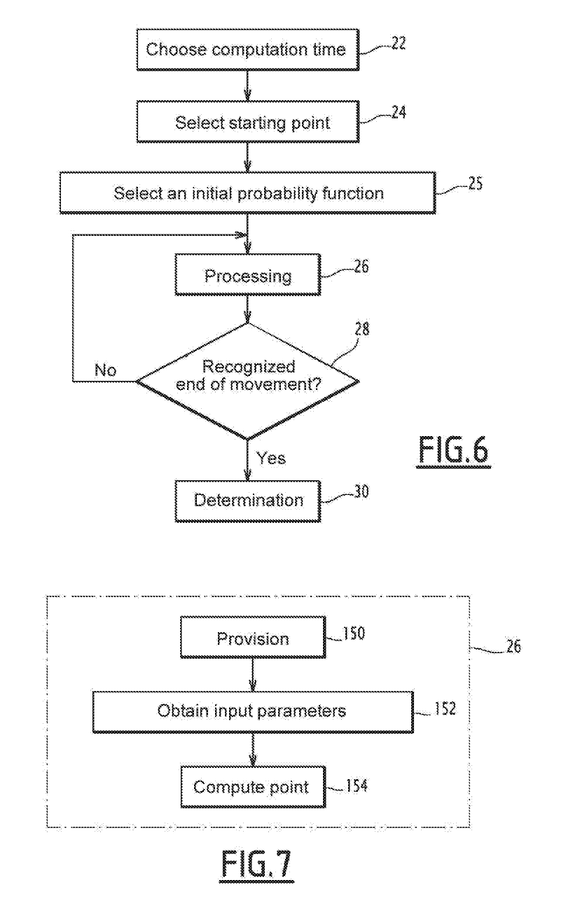

A third embodiment of the identification method is now described in reference to FIGS. 6 and 7.

As illustrated in FIG. 6, the identification method according to the third embodiment comprises a step 22 for choosing a computation time interval. The implementation of the step 22 for choosing a computation time interval is identical to the implementation described in reference to the first embodiment. The associated features are not repeated here, but also apply.

Optionally, as for the particular example of FIG. 6, the identification method according to the third embodiment comprises a step 24 for choosing a starting point. The implementation of the step 24 for selecting a starting point is identical to the implementation described in reference to the first embodiment. The associated features are not repeated here, but also apply.

The identification method according to the third embodiment also includes a step 25 for selecting an initial probability function.

The selection of the initial probability function is based, depending on the case, on a heuristic related to the input parameters chosen in the processing step 26, a choice of a function making it possible to minimize the later computation time, or a combination of the two. The selection of the initial probability function may also be based on knowledge of the phenomenon modeled by the system 10. For example, in the case of fencing, the guard position is more probable than the other positions as the initial position. Typically, to simplify the later computations, the initial probability function is, according to one preferred embodiment, a truncated Gaussian function. For example, in the case of fencing, it is possible to choose a truncated Gaussian function centered on the state corresponding to the guard position.

The identification method also includes a processing step 26. The processing step 26 is described in the following description in reference to the flowchart of FIG. 7.

In the case of the third embodiment, the identification method also includes a step 30 for determining the reference movement(s) representative of the movement by the player 12. The implementation of the step 30 for determining the reference movement(s) representative of the movement by the player 12 is identical to the implementation described in reference to the first embodiment. The associated features are not repeated here, but also apply.

According to the example of FIG. 7, the processing step 26 includes a provision sub-step 150, an obtainment sub-step 152 and a computation sub-step 154.

The provision 150 and obtainment 152 sub-steps are respectively identical to the provision and obtainment sub-steps 32 and 34 previously described in reference to FIG. 3. More specifically, this means that all of the remarks to describe the provision and obtainment sub-steps 32 and 34 also apply to the provision 150 and obtainment 152 sub-steps. As a result, the provision 150 and obtainment 152 sub-steps are not described in more detail below.

The computation sub-step 154 seeks to compute a point by using the quantified recursive Bayesian filtering technique.

In a manner known by those skilled in the art, the recursive Bayesian filtering technique is a probabilistic general approach for estimating an unknown recursive probability density function during a period using measurements and a mathematical model. In the particular case where the function for predicting a state from a preceding state is linear and where the probability distribution is a normal distribution optionally with multiple variables, the technique is a Kalman filter. Outside these conditions, according to another manner of tackling this approach, it is possible to use a Monte Carlo method to model the probability density by a set of particles. In this case, the technique is called particle filtering. Lastly, when the probability density is represented by a discrete grid, the recursive Bayesian filtering technique is qualified as a quantified recursive Bayesian filtering technique. This is the technique that was adapted, based on the terms described below, for the framework of a human movement recognition method.

Thus, during the computation sub-step 154, a point is computed belonging to a reference kinematic.

The computed point makes a function depending on the a posteriori conditional probability function extremal. “Extremal” means minimal or maximal. Preferably, the function that depends on the a posteriori conditional probability function is the identity function.

According to other embodiments, the function is more complex. Indeed, it is possible to consider the most probable reference movement or the reference movement corresponding to the point making the a posteriori conditional probability function maximal.

The a posteriori conditional probability function is defined by each point as the probability of the considered point being part of the movement to be identified, knowing that all of the input parameters have been provided since the beginning of the acquisition.

Furthermore, the a posteriori conditional probability function is computed by implementing a quantified recursive Bayesian filtering applied to the a posteriori conditional probability functions computed in the preceding iterations of the processing step and the initial probability function.

The quantification relates to the reference kinematics. It should be noted that, unlike the quantified recursive Bayesian filtering methods according to the state of the art, the grid does not pertain to the space of the input parameters, but rather the space of the reference kinematics. In other words, the grid proposed in the context of the invention quantifies the space of the states, whereas in the quantified recursive Bayesian filtering methods according to the prior art, the grid quantifies the space of the observations. Strictly speaking, the proposed grid also makes it possible to quantify the space of the observations, but this quantification is piecemeal, the points that are not part of a reference kinematic being omitted.

The identification method according to the third embodiment makes it possible to identify the movement on the fly. This allows an interaction with the player 12 when the interaction is more complex than simply pressing a button on the controller corresponding to a traditional video game experience.

The on-the-fly recognition also makes it possible to detect changes in the intention of the player 12 immediately. In the case of fencing, if the player 12 initially performs a “seconde hit”, the artificial intelligence of the player's 12 opponent performs the appropriate parry (a “seconde parry” or an “octave parry”). If the player 12, performing a feint, then changes line of attack to perform a “tierce hit”, such a change in movement is detected immediately, allowing the artificial intelligence to go from the movement that the artificial intelligence was performing (a “seconde parry”, for example), to a “high seconde parry”, thereby allowing the artificial intelligence to parry the new attack by the player 12 with the most appropriate movement taking account not only of the attack by the player 12, but also of the previous movement that the artificial intelligence was beginning to perform.

The identification method according to the third embodiment also allows the identification of a reference movement part and makes it possible to obtain information on the location of the part performed on the reference movement. For example, it is possible to determine that the identified movement part corresponds to what is done between the middle of the reference movement and three quarters of the implementation of the reference movement. This allows the artificial intelligence controlling the opponent of the player 12 to react at the right moment. An excessively early parry of the movement done by the player 12 is in fact easily bypassed by a feint. Conversely, an excessively late parry of the movement done by the player 12 only partially protects the opponent of the player 12, or provides no protection at all.

The identification method according to the third embodiment is applicable independently of the number of reference movements. As a result, flaws related to an excessively low number of reference movements are avoided. For example, it is possible to achieve maximum simplification, for example a hit from above or toward the right as in the case of a game on the Wii console, to which the two corresponding parries and the en garde position are added. In this extremely simple case, (2+2+1)²=25 different movements are taken into account. It is also possible to ignore certain movements, for example by only authorizing movements to or from the guard. Only 4×2=8 different movements then remain. In case of transition from a parry to an attack or vice versa, however, the chances of correct identification of the movement are greatly decreased. The method has been validated on 60 different reference kinematics.

The identification method according to the third embodiment makes it possible to take account of all of the parameters acquired by the device 16 at the same pace that the device 16 acquires the parameters. Typically, as an illustration, the identification method according to the third embodiment is capable of taking account of 60 movement parameters acquired every 1/30^{th} of a second or is capable of taking account of six movement parameters acquired every 1/60^{th} of a second.

The identification method according to the third embodiment is also capable of detecting movement changes. Such a detection capacity is implemented in two different cases: when going from a first finished reference movement to a second beginning movement and when going from a first reference movement in progress to another reference movement in progress. The first case guarantees fluidity in the identification of the movement, the player 12 naturally going from one completed reference movement to another reference movement, without needing to pause between two successive movements. The second case corresponds to performing feints, which occurs frequently in fencing.

The identification method according to the third embodiment makes it possible to identify the movement in less than thirty seconds on a single (performance) thread of a game console. This makes it possible to reserve the other (performance) threads of the game consoles for graphics and sound. The implementation of the identification method according to the third embodiment is therefore transparent for the player 12.

The identification method according to the third embodiment also makes it possible to detect the intention of the player 12.

The identification method according to the third embodiment ensures a refined understanding of the movement to be identified as the movement by the player 12 takes place. The more time that passes, or more accurately, the further the player 12 progresses in performing his movement, the better the artificial intelligence is able to correctly analyze the movement by the player 12. This corresponds exactly to a simulation of reality: a fencer determines, with increasing certainty, the movement performed by his enemy as his enemy performs it.

The identification method according to the third embodiment is able to segment the movement automatically with no indication of the beginning or end of a movement.

The identification method according to the third embodiment takes account of the fact that certain characteristic parameters of the movement to be identified by the device 16 are more or less valid. This makes it possible to guarantee a convergence of the identification method according to the third embodiment even when certain provided characteristic parameters are abnormal.

Furthermore, the identification method according to the third embodiment makes it possible to manage the insufficiencies of the device 16. For example, when information is missing regarding the orientation of the wrist or the position of the blade, the identification method nevertheless makes it possible to identify reference movements by using the position of the joints of the body of the player 12. According to another example, without knowing the posture of the body, the identification method according to the third embodiment is also capable of determining the movement performed by the player 12 only with the position and orientation of the blade.

The identification method according to the third embodiment also has the advantage of being independent of time. Thus, it is of little importance whether the movements of the player 12 are done very quickly, very slowly, quickly at the beginning and slowly at the end or the other way around. Such variability in the performance speed has no impact on the identification, and thus on the reaction possibilities of the artificial intelligence.

The identification method according to the third embodiment also has the advantage of being independent of the morphology of the player 12. The overall differences in size or proportions, in particular relative to the width of the shoulders or the length of the arms of the player 12, are taken into account.

The identification method according to the third embodiment, in particular combined with the method according to the fifth embodiment, also makes it possible to obtain a computation time per temporal frame on a single (performance) thread of less than 1/30^{th} of a second for about 1000 different reference movements in the knowledge base. This makes it possible to then include, in the same temporal frame, an artificial intelligence producing a response by an opponent or allied with the character of the player 12 from recognition information and information accessible to the artificial intelligence.

The identification method according to the third embodiment makes it possible to obtain a better identification rate than the recognition rate obtained with the methods of the state of the art. Typically, in the case of fencing, the identification rate of a point in time of a movement is strictly greater than 85%. Such precision is only achieved with the methods of the state of the art at the end of the movement, with the information of all of the points in time of the movement. Furthermore, this identification rate is obtained for 60 reference kinematics, versus a maximum of about ten for the methods of the state of the art.

The identification method according to the third embodiment also has the advantage of guaranteeing a maximum identification rate in the time interval during which the artificial intelligence has to make a response decision.

According to one preferred embodiment, the identification method according to the third embodiment also makes it possible to predict the likeliest future postures of the player 12 and/or the positions of the blade of the player 12. The artificial intelligence is then able to make decisions taking account of the predicted postures and/or positions. A decision for example consists of determining the most timely action among an attack, a counter-attack or a parry. According to the most highly evolved operating modes, the decision takes account of a specific behavior to simulate a human opponent. For example, to simulate an impatient human being, a counter-attack will be favored relative to a parry. Optionally, the identification method according to the third embodiment is able to provide an indicator of the performed movement. Such information makes it possible to obtain a performance indicator of the movement performed by the player 12. For example, the gravity of the inflicted injury is thus determined in case of an attack that is not parried or the imbalance of the opponent in case of successful parry with excellent quality. The quality indicator for the movement also makes it possible to teach the player 12 to perform the reference movements correctly, which may correspond to a technique used outside any recognition framework. For example, in a fencing game, this makes it possible to improve one's fencing technique. The movement quality indicator also makes it possible to facilitate the identification of later movements by the same player 12.

Advantageously, the identification method includes a step for filtering the movements by the player 12. This for example makes it possible to favor viewing or avoid taking account of abnormal positions of certain joints.

Preferably, the identification method according to the third embodiment includes a step for reconstructing the identified movement(s) performed by the player 12. This makes it possible to facilitate the learning by the artificial intelligence of the specificities of the player 12, in particular the choices, strengths and past errors. According to one preferred embodiment, the artificial intelligence is able to provide the player 12 with advice to improve his practice.

According to another embodiment of the identification method according to the third embodiment, each iteration of the processing step 26 also includes a sub-step for choosing the computing time interval for the following iteration. According to one alternative, the processing step 26 does not include an obtainment sub-step 102. In this case, the input parameters are the provided characteristic parameters. According to still another embodiment, the quantified recursive Bayesian filtering implemented upon each iteration of the processing step 26 is also applied to the points computed in the previous iterations of the processing step 26.

Optionally, each iteration of the processing step 26 further includes a sub-step for detecting a change of reference kinematic if the reference kinematic determined in the determination sub-step is different from the reference kinematic determined in the previous iteration of the processing step 26.

According to one alternative, each iteration of the processing step 26 comprises a step for estimating at least one transition probability between two points each belonging to a reference kinematic. According to one such embodiment, the quantified recursive Bayesian filtering implemented upon each iteration of the processing step 26 accounts for the at least one estimated transition probability.

To prohibit passages between reference movement parts whereof the reference movements are incompatible with one another, the transition probability between a first reference movement point and another point of the second reference movement is set to a zero value.

Likewise, when the incompatibility pertains to the points themselves due to the continuity of the movement by the player 12 (the player 12 for example does not have the possibility of going directly from a proximal position relative to the device 16 to a distal position without passing through intermediate positions), the transition probability between the two points is set to a zero value.

In the specific case of two points belonging to the same reference kinematic, the transition probability between the two points depends on a computation parameter depending on the time.

According to another embodiment, the transition probability between the two points depends on the two points and an estimate of the current movement speed of the player 12. As an example, the current movement speed of the player 12 is computed from the reference kinematics. The movement speed of the player 12 is preferably the Euclidean distance between two successive points in time of reference movements (reference movements that were used to determine the reference kinematics).

According to another example, the current movement speed of the player 12 is computed from the displacement of the movement to be identified, measured during the chosen time interval. The movement speed of the player 12 is preferably the Euclidean distance between two successive points in time of reference movements (reference movements that were used to determine the reference kinematics).

According to one advantageous embodiment, the likelihood of observation of the input parameters is computed knowing the sequence of computed points. The value of the likelihood relative to the state whose a posteriori probability is largest or relative to the most probable state makes it possible to perform a test on the quality of the method. When the value is too low, the obtained identification is then considered to be unreliable. Conversely, when the likelihood value is greater than or equal to a given threshold, the obtained identification of the movement by the player 12 is considered to be reliable. According to another embodiment, the reaction by the artificial intelligence to the movements by the player 12 depends on the difficulty level chosen by the video game player 12 to run the video game.

By way of generalization, it will be understood that the identification method according to the third embodiment is a particular case of a method for analyzing a movement by a human being. Indeed, the proposed method makes it possible to determine any information relative to the movement to be analyzed. As one particular example, a method may be proposed for predicting the movement to be analyzed, the information pertaining to at least one following point of the movement. Alternatively, a method is also proposed for filtering the movement to be analyzed.

Furthermore, in the general case, it is not a point that is sought, but rather, in the computation step, the conditional probability is computed for each state, then a computation is done using the a posteriori conditional probabilities.

Method for Identifying a Movement by a Player 12 by Using a Simplification of the Hidden Markov Model

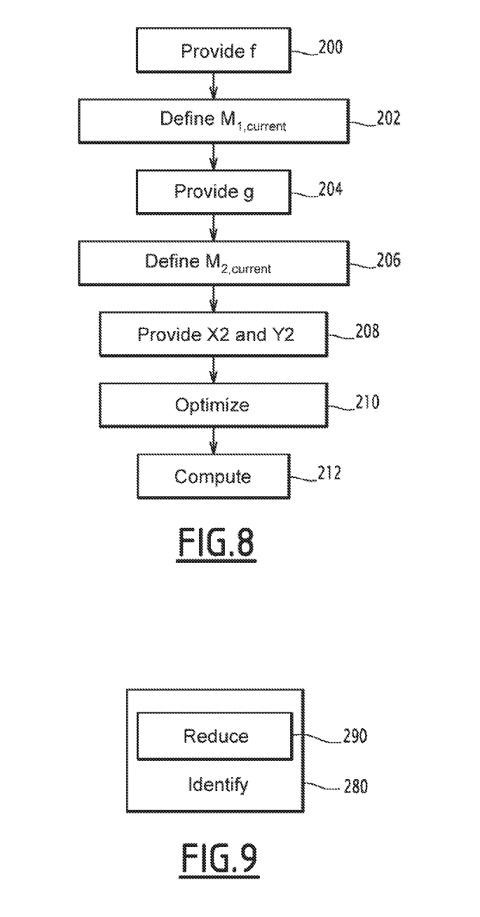

The method for identifying a movement by the player 12 according to the forth embodiment is based on a processing method to compute a function relative to a first event, in the case at hand the movement by the player 12. A flowchart of an example implementation of the processing method is illustrated in reference to FIG. 8.

The set of events can be represented using an initial hidden Markov model. The set of events corresponds, in the context of the invention, to the different reference kinematics.

The initial hidden Markov model is characterized by states, observations, a matrix of transition probabilities between the states, and observation probability parameters represented for the sequence as an example, as a matrix of probabilities of the occurrence of an observation for each state. In this context, a vector is a matrix.

In the context of recognizing the movement by the player 12, the states are the points of the different reference kinematics. The number of states is denoted P, P being a strictly positive integer.

To recognize the movement by the player 12, the observations are the input parameters as previously defined in reference to the identification method according to the first embodiment, the second embodiment and the third embodiment. The number of parameters is denoted Q, Q being a strictly positive integer.

The transition probability matrix between the states yields, for each state, the probability of performing a transition toward another state. In the general case, the transition probability matrix between the states, simply called transition matrix hereinafter, is therefore a square matrix whose size is the number of states squared, i.e., P². Furthermore, in the more general case, the transition matrix is a matrix optionally varying over time and optionally depending on co-variables, which in turn possibly depend on the time. The transition matrix is denoted φ hereinafter.

According to one preferred embodiment, the transition probability between two states is estimated. Many embodiments make it possible to estimate the transition probability between two states. As an example, in the case of a left-right hidden Markov model, when a state has already been achieved, prohibiting a return toward the state that has already been achieved amounts to requiring the transition probability between the current state and the state already computed to be zero.

Similarly, to prohibit passages between reference movement parts whereof the reference movements are incompatible with one another, the transition probability between a state of a first reference movement and another state of a second reference movement is set to a zero value.

Likewise, when the incompatibility pertains to the proximity of the positions related to the states themselves due to the continuity of the movement by the player 12 (the player 12 does not have the possibility of going directly from a proximal position relative to the device 16 to a distal position without passing through intermediate positions), the transition probability between the two states is set to a zero value.

In the specific case of two states belonging to the same reference kinematic, the transition probability between the two states depends on a computation parameter depending on the time, for example a co-variable. The computation parameter is for example the current movement speed of the player 12.

The matrix of the occurrence probabilities of an observation for each state is called observation matrix hereinafter. The observation matrix is, by definition, a matrix providing, for each state, the probability of occurrence of an observation, for each observation. In other words, the observation matrix groups together all of the conditional probabilities of the occurrence of an observation, knowing that the observed element is in a given state, for each state. This means that the observation matrix is a matrix with P columns for Q rows. The observation matrix is denoted Θ hereinafter.

In the context of a hidden Markov model, each event is characterized by a temporal sequence of observations and a temporal sequence of states. For the illustrated specific case, this means that each movement by the player 12 is a temporal sequence of points and a sequence of input parameters. More accurately, a temporal sequence of observations (input parameters) is accessible, and from this sequence, a temporal sequence of states (points) is deduced, which is the task of the hidden Markov model. The learning of the hidden Markov model, i.e., the determination of the matrix of the states and observation variables, becomes impossible when the dimensionality of the problem to be addressed becomes too large, i.e., at least one of the integers P or Q is large. For example, an integer P is considered to be large if it is greater than 20.

The processing method comprises a step 200 for providing a first constraint function. The first constraint function is denoted f.

The processing method comprises a step 202 for defining a first current computing matrix M_{1,current} such that the image of the first current computing matrix M_{1,current} by the first constraint function f is the observation matrix Θ. Mathematically, this is written in a matricial form as: f (M_{1,current})=Θ.

In this context, the expression “image” is also understood as referring to cases where the first constraint function f is a function not depending solely on the first current computing matrix M_{1,current}. Mathematically, this is written in a matricial form as: f (Θ, U)=M_{1,current}

where U is a first intermediate matrix, able to be reduced in some particular cases to a scalar.

According to a first condition, the first constraint function f is chosen such that the size of the first current computing matrix M_{1,current} is smaller than the size of the observation matrix Θ.

Preferably, the first current computing matrix M_{1,current} is a vector.

The processing method comprises a step 204 for providing a second constraint function, denoted g.

The processing method includes a step 206 for defining a second current computing matrix M_{2,current} such that the image of the second constraint function g is the transition matrix φ. Mathematically, this is written in a matricial form as: g (M_{2,current})=φ.

In this context, the expression “image” is also understood as referring to cases where the second constraint function f is a function not depending solely on the second current computing matrix M_{2,current}. Mathematically, this is written in a matricial form as: g (B, M_{2,current})=φ

where B is a second intermediate matrix, able to be reduced in some particular cases to a scalar.

According to a second condition, the second constraint function g is chosen such that the size of the second current computing matrix M_{2,current} is smaller than the size of the transition matrix φ.

At least one of the two constraint functions f and g is such that the first condition or the second condition is verified.

The two functions f and g represent a priori knowledge about the parameters of the problem preferably in the form of constraints. The aim is to reduce the number of parameters to be estimated by introducing constraints. As an example, the observation probability is computed as the Malahanobis distance from the reference kinematics.

This a priori knowledge, for example for fencing, may, knowing that the observation probability parameters are the positions along the average movement and the variances for each group of parameters, be:
for the first constraint function f: the first intermediate matrix U is a scalar parameter making it possible to localize oneself on the first constraint function f, which is the function of the average movement and the associated variance.
for the second constraint function g: the second constraint function g is an on-the-fly computation of the transition matrix using the speed (the co-variable) to determine the transition probability between two states of the same reference movement. The second intermediate matrix B is the set of scalar parameters making it possible to compute the transition probability. For example, the second intermediate matrix B comprises the variance of the expected error on the speed, the variance of the error on the transition between the end of one movement and the beginning of another, the moment where one considers that a movement is potentially finished, the a priori probability of changing reference movement, the variance of the error on the corresponding position in case of movement change in the determined position when matching average movements and the probability below which a probability is considered to be zero.

According to one embodiment, one of the two constraint functions f and g is the identity function.

The processing method comprises a step 208 for providing the temporal sequence of states denoted X2 and the temporal sequence of observations denoted Y2 for a second event.

Preferably, the second event is chosen as being a player 12 performing a reference movement.

The processing method then includes an optimization step 210 to obtain a first optimal computing matrix M_{1,optimal} and a second optimal computing matrix M_{2,optimal}.

The optimization step 210—is carried out by minimizing an optimization function denoted χ. The optimization function χ has the first current computing matrix M_{1,current} and the second current computing matrix M_{2,current} as inputs.

Furthermore, the optimization function χ depends at least on the temporal sequence of observations Y2 provided for the second event. The optimization function χ also depends on the number of states. According to one particular embodiment, the optimization function χ also depends on the temporal sequence of states X2.

As an example, the optimization function χ is a likelihood function. In this case, the optimization function χ may be written as a function with three variables of the transition matrix φ, the observation matrix Θ, and the temporal sequence of observations Y2.

It is possible to show that the optimization function χ has at least one extremum that a minimization method makes it possible to approach.

Alternatively, this may be a maximization method (for example, for the case of likelihood).

As an example, the minimization method is a gradient descent (gradient ascent, respectively, for a maximization method).

Preferably, the gradient descent is implemented by a learning method.

According to another embodiment, the minimization method is a method of the EM type, for example a Baum-Welch method.

The processing method then also includes a step 212 for computing the function relative to the first event from the first optimal computing matrix M_{1,optimal} and the second optimal computing matrix M_{2,optimal}.

Applied to the case of movement identification, the method according to the fourth embodiment comprises the different steps of the processing method and step 212 is a step for determining the movement.

Due to the reduction in the dimensionality of the initial hidden Markov model, the computation step 212 becomes a more rapidly converging step. This is in particular due to the fact that unlike the transition matrix φ and the observation matrix Θ of the initial Markov model, the first optimal computing matrix M_{1,optimal} and the second optimal computing matrix M_{2,optimal} are not dependent on the time. This greatly simplifies the computational complexity of the problem to be addressed.

The identification method according to the fourth embodiment makes it possible to identify the movement on the fly. This allows an interaction with the player 12 when the interaction is more complex than simply pressing a button on the controller corresponding to a traditional video game experience.

The on-the-fly recognition also makes it possible to detect changes in the intention of the player 12 immediately. In the case of fencing, if the player 12 initially performs a “seconde hit”, the artificial intelligence of the player's 12 opponent performs the appropriate parry (a “seconde parry” or an “octave parry”). If the player 12, performing a feint, then changes line of attack to perform a “tierce hit”, such a change in movement is detected immediately, allowing the artificial intelligence to go from the movement that the artificial intelligence was performing (a “seconde parry”, for example), to a “high seconde parry”, thereby allowing the artificial intelligence to parry the new attack by the player 12 with the most appropriate movement taking account not only of the attack by the player 12, but also of the previous movement that the artificial intelligence was beginning to perform.

The identification method according to the fourth embodiment also allows the identification of a reference movement part and makes it possible to obtain information on the location of the part performed on the reference movement. For example, it is possible to determine that the identified movement part corresponds to what is done between the middle of the reference movement and three quarters of the implementation of the reference movement. This allows the artificial intelligence controlling the opponent of the player 12 to react at the right moment. An excessively early parry of the movement done by the player 12 is in fact easily bypassed by a feint. Conversely, an excessively late parry of the movement done by the player 12 only partially protects the opponent of the player 12, or provides no protection at all.

The identification method according to the fourth embodiment is applicable independently of the number of reference movements. As a result, flaws related to an excessively low number of reference movements are avoided. For example, it is possible to achieve maximum simplification, for example a hit from above or toward the right as in the case of a game on the Wii console, to which the two corresponding parries and the en garde position are added. In this extremely simple case, (2+2+1)²=25 different movements are taken into account. It is also possible to ignore certain movements, for example by only authorizing movements to or from the guard. Only 4×2=8 different movements then remain. In case of transition from a parry to an attack or vice versa, however, the chances of correct identification of the movement are greatly decreased. The method has been validated on 60 different reference kinematics.

The identification method according to the fourth embodiment makes it possible to take account of all of the parameters acquired by the device 16 at the same pace that the device 16 acquires the parameters. Typically, as an illustration, the identification method according to the fourth embodiment is capable of taking account of 60 movement parameters acquired every 1/30^{th} of a second or is capable of taking account of 6 movement parameters acquired every 1/60^{th} of a second. The identification method according to the fourth embodiment is also capable of detecting movement changes. Such a detection capacity is implemented in two different cases: when going from a first finished reference movement to a second beginning movement and when going from a first reference movement in progress to another reference movement in progress. The first case guarantees fluidity in the identification of the movement, the player 12 naturally going from one completed reference movement to another reference movement, without needing to pause between two successive movements. The second case corresponds to performing feints, which occurs frequently in fencing. The identification method according to the fourth embodiment makes it possible to identify the movement in less than thirty seconds on a single (performance) thread of a game console. This makes it possible to reserve the other (performance) threads of the game consoles for graphics and sound. The implementation of the identification method is therefore transparent for the player 12. The identification method according to the fourth embodiment also makes it possible to detect the intention of the player 12. The identification method according to the fourth embodiment ensures a refined understanding of the movement to be identified as the movement by the player 12 takes place. The more time that passes, or more accurately, the further the player 12 progresses in performing his movement, the better the artificial intelligence is able to correctly analyze the movement by the player 12. This corresponds exactly to a simulation of reality: a fencer determines, with increasing certainty, the movement performed by his enemy as his enemy performs it.

The identification method according to the fourth embodiment is able to segment the movement automatically with no indication of the beginning or end of a movement. The identification method according to the fourth embodiment takes account of the fact that certain characteristic parameters of the movement to be identified by the device 16 are more or less valid. This makes it possible to guarantee a convergence of the identification method according to the fourth embodiment even when certain provided characteristic parameters are abnormal. Furthermore, the identification method according to the fourth embodiment makes it possible to manage the insufficiencies of the device 16. For example, when information is missing regarding the orientation of the wrist or the position of the blade, the identification method according to the fourth embodiment nevertheless makes it possible to identify reference movements by using the position of the joints of the body of the player 12. According to another example, without knowing the posture of the body, the identification method according to the fourth embodiment is also capable of determining the reference movement performed by the player 12 only with the position and orientation of the blade.

The identification method according to the fourth embodiment also has the advantage of being independent of time. Thus, it is of little importance whether the movements of the player 12 are done very quickly, very slowly, quickly at the beginning and slowly at the end or the other way around. Such variability in the performance speed has no impact on the identification, and thus on the reaction possibilities of the artificial intelligence.

The identification method according to the fourth embodiment also has the advantage of being independent of the morphology of the player 12. The overall differences in size or proportions, in particular relative to the width of the shoulders or the length of the arms of the player 12, are taken into account.

The identification method according to the fourth embodiment, in particular combined with the method according to the fifth embodiment, also makes it possible to obtain a computation time per temporal frame on a single (performance) thread of less than 1/30^{th} of a second for about 1000 different reference movements in the knowledge base. This makes it possible to then include, in the same temporal frame, an artificial intelligence producing a response by an opponent or allied with the character of the player 12 from recognition information and information accessible to the artificial intelligence.

The identification method according to the fourth embodiment makes it possible to obtain a better identification rate than the recognition rate obtained with the identification methods of the state of the art. Typically, in the case of fencing, the identification rate of a point in time of a movement is strictly greater than 85%. Such precision is only achieved with the methods of the state of the art at the end of the movement, with the information of all of the points in time of the movement. Furthermore, this identification rate is obtained for 60 reference kinematics, versus a maximum of about ten for the methods of the state of the art.

The identification method according to the fourth embodiment also has the advantage of guaranteeing a maximum identification rate in the time interval during which the artificial intelligence has to make a response decision.

According to one preferred embodiment, the identification method according to the fourth embodiment also makes it possible to predict the likeliest future postures of the player 12 and/or the positions of the blade of the player 12. The artificial intelligence is then able to make decisions taking account of the predicted postures and/or positions. A decision for example consists of determining the most timely action among an attack, a counter-attack or a parry. According to the most highly evolved operating modes, the decision takes account of a specific behavior to simulate a human opponent. For example, to simulate an impatient human being, a counter-attack will be favored relative to a parry.

Optionally, the identification method according to the fourth embodiment is able to provide an indicator of the performed movement. Such information makes it possible to obtain a performance indicator of the movement performed by the player 12. For example, the gravity of the inflicted injury is thus determined in case of an attack that is not parried or the imbalance of the opponent in case of successful parry with excellent quality. The quality indicator for the movement also makes it possible to teach the player 12 to perform the reference movements correctly, which may correspond to a technique used outside any recognition framework. For example, in a fencing game, this makes it possible to improve one's fencing technique. The movement quality indicator also makes it possible to facilitate the identification of later movements by the same player 12.

Advantageously, the identification method according to the fourth embodiment includes a step for filtering the movements by the player 12. This for example makes it possible to favor viewing or avoid taking account of abnormal positions of certain joints.

Preferably, the identification method according to the fourth embodiment includes a step for reconstructing the identified movement(s) performed by the player 12. This makes it possible to facilitate the learning by the artificial intelligence of the specificities of the player 12, in particular the choices, strengths and past errors. According to one preferred embodiment, the artificial intelligence is able to provide the player 12 with advice to improve his practice.

Alternatively, the hidden Markov model is a left-right Markov model.

According to one embodiment, at least one of the two constraint functions f, g also depends on a third, time-dependent matrix Z.

Depending on the case, the third matrix Z is a function of the observations. For example, the value of the third matrix Z at the moment t is equal to the value of the Q observations at the moment t from which the value of the Q observations is subtracted at moment t−1. In some cases, it should be noted that due to the invalidity of certain parameters, instead of a subtraction operation, the Euclidean distance between the value of the Q observations at the moment t and subtracted from the value of the Q observations at the moment t−1 is considered.

The third matrix Z is a way to eliminate the temporal component of the transition matrices φ, the observation matrix Θ so that the optimal computation matrices M_{1,optimal} and M_{2,optimal} do not depend on the time.

According to another embodiment, the second constraint function g depends on several variables. In particular, according to one specific case, the second constraint function g at a moment t depends on the transition matrices φ at the earlier moments, the observation matrix Θ at the earlier moments and the second current computation matrix M_{2,current}. According to another specific case, the second constraint function g at a moment t depends on the transition matrices φ at the earlier moments, the observation matrix Θ at the earlier moments and the second current computation matrix M_{2,current} and the third matrix Z.

According to still another embodiment, the optimization function is a set of two functions, one optimizing only the first current matrix M_{1,current} and the other optimizing only the second current matrix M_{2,current}.

According to another embodiment, the processing method is applied to voice recognition.

Generally, any type of function or task computation can be considered in the computing step 212. In particular, an inference, filtering, smoothing or most probable explanation computation is possible. The associated computing methods are methods of the state of the art applied to the first optimal computing matrix M_{1,optimal} and the second optimal computing matrix M_{2,optimal}.

The processing method is therefore a method making it possible to improve all methods involving a hidden Markov model, especially when the hidden Markov model has a significant dimensionality, which may even be prohibitive for computational implementation.

Method for Identifying a Movement by a Player 12 by Reducing the Number of Possible Transitions

According to a fifth embodiment illustrated by FIG. 9, the identification method includes a step 280 for identifying the movement most representative of the movement to be identified.

The most representative movement is a series of a first number of reference movement parts. The series is only meaningful for one travel direction, the travel direction that is typically chosen as the advance of the movement. This is what we will consider in the rest of the description, knowing that other directions would be conceivable.

“Series” means that each part is framed by at least one separate part of the same reference movement or a part of another reference movement.

In other words, the series is partitioned in maximal parts for each reference movement.

A maximal part is a part that cannot be extended. In this context, this means that for a point in time situated before or after, there is a change in reference movement.

The term “the most representative” means that the most representative movement makes a score function extremal, in particular maximizing it.

Depending on the case, the score function is a similarity score, an energy or probability functions. Examples of similarity score, energy or probability function definitions are illustrated by the identification methods previously described.

The first number is an integer greater than or equal to 1.

Typically, the first number is an integer less than or equal to 3 for a single acquired movement, and therefore 3 divided by the average number of points in time per reference movement.

According to one preferred embodiment, the identification step 280 is carried out by implementing an identification method according to the first embodiment.

Alternatively, the identification step 280 is carried out by implementing an identification method according to the second embodiment.

According to another alternative, the identification step 280 is carried out by implementing an identification method according to the third embodiment.

Alternatively, the identification step 280 is carried out by implementing an identification method according to the fourth embodiment.

The identification method according to the fifth embodiment also includes a step 290 for reducing the number of possible transitions between two reference movement kinematics by using at least one penalty rule for introducing an additional reference movement part during the implementation of the identification step 280.

In other words, the reducing step 290 is a step for reducing the value of the first number by using at least one penalty rule, each penalty rule penalizing the transition between at least two reference movement kinematics in the most representative movement. This is diagrammatically shown in FIG. 9 by the fact that the rectangle designated by reference 290 and comprising the word “reduction” is included in the rectangle designated by reference 280 and comprising the word “identification”.

Multiple penalty rules can be considered. Each rule makes it possible to reduce the computation complexity of the identification step 280. Any combination of rules described below can be considered.

According to a first penalty rule, the introduction of an additional reference movement part during the identification step 280 is penalized if the starting state of the additional reference movement part is different from the starting state and the arrival state of the part previously computed.

In other words, the first penalty rule penalizes the transition between two separate reference kinematic parts having a different arrival state and/or starting state.

According to a second penalty rule, the introduction of an additional reference movement part during the identification step 280 is penalized if the score function used in the identification step 280 is decreased by the introduction of the additional reference movement part. In other words, the second penalty rule penalizes the transition to an additional reference kinematic part decreasing the score function associated with the identification of the other reference kinematic parts already identified.

According to a third penalty rule, the introduction of an additional reference movement part during the identification step 280 is penalized if the transition between the additional reference movement part and a part previously computed does not fulfill a first criterion.

For the first criterion, a distance is defined between the additional reference movement part and the part previously computed as the spatial difference between the part previously computed and the additional reference movement part. The first criterion is to choose the minimal distance between an additional reference movement part and the part previously computed.

In other words, the third penalty rule penalizes the presence of an additional reference kinematic part not having a minimal distance with the piece of the series previously computed.

According to a fourth penalty rule, the introduction of an additional reference movement part during the identification step 280 is penalized if the transition between the additional reference movement part and a part previously computed does not fulfill a second criterion. It should be noted that the fourth penalty rule essentially applies for the same reference movement. To apply such a penalty rule, the identification method according to the fifth embodiment includes a measurement of the distance actually traveled by the player 12. The second criterion is to minimize the deviation between the measured distance and the distance corresponding to the identified movement by introducing the additional reference movement part. More specifically, the deviation between the measured distance and that traveled by the kinematic model between the preceding step of the movement by the player 12 and the current movement is minimized.

In other words, the fourth penalty rule penalizes the presence of an additional reference kinematic part not minimizing the deviation between the measured distance and the distance corresponding to the most representative movement.

According to a fifth penalty rule, the introduction of an additional part of a same reference movement increasing the first number or causing it to pass above a threshold is penalized. The fifth penalty rule corresponds to an expression of the fact that over a same reference movement, it is possible to stagnate or advance, but not to withdraw.

In other words, the fifth penalty rule penalizes the presence of two parts of a same reference movement not respecting a predefined order. Preferably, the predefined order is an increasing order. The increasing order is understood relative to an increasing direction of advance over the movement of the player 12.

For the rest, it is assumed that a penalty function for the introduction of an additional reference movement part is introduced in the reduction step 290.

According to a sixth penalty rule, the penalty function is not constant and does not result from any learning mechanism implemented during the identification step 280.

According to a seventh penalty rule, the penalty function depends on the starting state of the additional reference movement part and/or the starting state and/or the arrival state of the part previously computed.

According to an eighth penalty rule, the penalty function depends on the score function used in the identification step 280 and computed in the preceding iteration.

According to a ninth penalty rule, the penalty function depends on the equality between the starting state of the additional reference movement part and the starting state of the reference movement part previously computed.

According to a tenth penalty rule, the penalty function depends on the equality between the starting state of the additional reference movement part and the arrival state of the reference movement part previously computed.

According to an eleventh penalty rule, the penalty function depends on the equality between the arrival state of the additional reference movement part and the arrival state of the reference movement part previously computed.

According to a twelfth penalty rule, the penalty function depends on the equality between the arrival state of the additional reference movement part and the starting state of the reference movement part previously computed.

According to a thirteenth penalty rule, the penalty function depends on the number of shared states between two considered reference movements.

Preferably, each penalty rule is binary. This means that for each penalty rule, the penalized transitions are completely excluded, while the other transitions are allowed. Thus, a transition targeted by the binary penalty rule is prohibited, since it is associated with a “0”, while a transition not targeted by the binary penalty rule is allowed, since it is associated with a “1”.

According to one preferred embodiment, the identification step is iterative and each reference kinematic part has a starting state and an arrival state, and in the reduction step, a used penalty rule associates a penalty with a transition from a reference kinematic part identified in a previous iteration of the identification step toward an additional reference kinematic part, when the starting state of the additional part is different from the starting state of the identified reference kinematic part and the final state of the identified reference kinematic part.

According to one preferred embodiment, the identification step includes an iterative processing step comprising computing a score function associated with the identification of a reference kinematic part for a part of the movement to be identified and in the reduction step, a used penalty rule associates a penalty with a transition from a reference kinematic part and/or to an additional reference kinematic part, depending on the score functions associated during previous iterations with said reference kinematic parts.

According to another preferred embodiment, each part of each reference kinematic is associated with one or several other reference kinematic parts by an association accompanied by a cost and wherein a penalty rule used prohibits the transitions between non-associated reference kinematic parts and penalizes transitions between two associated reference kinematic parts by the value of the cost accompanied by the association of the two considered reference kinematic parts.

According to still another embodiment, the identification step is iterative and wherein the method includes a step for measuring the distance actually traveled by the human being, in order to obtain a measured distance, and, in the reduction step, a used penalty rule penalizes the transition from a reference kinematic part identified in a previous iteration of the identification step to an additional reference kinematic part with a value depending on the deviation between the measured distance and the distance traveled from the reference kinematic part identified in the previous iteration of the identification step to the additional reference kinematic part.

It is possible to show the effectiveness of the penalty rules by considering the example of a simplified fencing case in sand. For such an example, it is considered that there are 4 guards (prime, seconde, tierce and quarte guards), 14 attacks (prime, seconde to the leg or cheek, tierce to the cheek, throat, side or leg, quarte to the cheek, throat, side or leg, quinte to the head, septime to the leg or cheek) and 16 parries (prime, low prime and high prime, seconde and high seconde, tierce, low tierce and high tierce, quarte, low quarte, high quarte and horizontal quarte, quinte, sixte, septime, octave).

For the example, three manners of performing a reference movement are defined: direct, exaggerated or circular. Since 34 movements exist (4 guards, 14 attacks and 16 parries), and assuming that each reference movement comprises 30 points in time representing the evolution of the parameters, the total number of transitions is equal to (3*30*34)²=9,363,600 transitions.

By applying the identification method according to the fifth embodiment and the first penalty rule, the total number of transitions is reduced to 2×34×(3×20)²=550,800 transitions.

By applying the identification method according to the fifth embodiment and the combination of first penalty rule and the eighth penalty rule, the total number of transitions is reduced to 2×34×3×30=6,120 transitions.

By applying the identification method according to the fifth embodiment and the combination of first penalty rule, the second penalty rule and the third penalty rule, the total number of transitions is reduced to 2×34×3=204 transitions.

Such a number of transitions is small enough to allow identification of the movement by the player 12 on the fly. This allows an interaction with the player 12 when the interaction is more complex than simply pressing a button on the controller corresponding to a traditional video game experience.

The on-the-fly recognition also makes it possible to detect changes in the intention of the player 12 immediately. In the case of fencing, if the player 12 initially performs a “seconde hit”, the artificial intelligence of the player's 12 opponent performs the appropriate parry (a “seconde parry” or an “octave parry”). If the player 12, performing a feint, then changes line of attack to perform a “tierce hit”, such a change in movement is detected immediately, allowing the artificial intelligence to go from the movement that the artificial intelligence was performing (a “seconde parry”, for example), to a “high seconde parry”, thereby allowing the artificial intelligence to parry the new attack by the player 12 with the most appropriate movement taking account not only of the attack by the player 12, but also of the previous movement that the artificial intelligence was beginning to perform.

The identification method according to the fifth embodiment also allows the identification of a reference movement part and makes it possible to obtain information on the location of the part performed on the reference movement. For example, it is possible to determine that the identified movement part corresponds to what is done between the middle of the reference movement and three quarters of the implementation of the reference movement. This allows the artificial intelligence controlling the opponent of the player 12 to react at the right moment. An excessively early parry of the movement done by the player 12 is in fact easily bypassed by a feint. Conversely, an excessively late parry of the movement done by the player 12 only partially protects the opponent of the player 12, or provides no protection at all.

The identification method according to the fifth embodiment is applicable independently of the number of reference movements. As a result, flaws related to an excessively low number of reference movements are avoided. For example, it is possible to achieve maximum simplification, for example a hit from above or toward the right as in the case of a game on the Wii console, to which the two corresponding parries and the en garde position are added. In this extremely simple case, (2+2+1)²=25 different movements are taken into account. It is also possible to ignore certain movements, for example by only authorizing movements to or from the guard. Only 4×2=8 different movements then remain. In case of transition from a parry to an attack or vice versa, however, the chances of correct identification of the movement are greatly decreased. The identification method according to the fifth embodiment makes it possible to take account of all of the parameters acquired by the device 16 at the same pace that the device 16 acquires the parameters. Typically, as an illustration, the identification method according to the fifth embodiment is capable of taking account of 60 movement parameters acquired every 1/30^{th} of a second or is capable of taking account of six movement parameters acquired every 1/60^{th} of a second. The identification method according to the fifth embodiment is also capable of detecting movement changes. Such a detection capacity is implemented in two different cases: when going from a first finished reference movement to a second beginning movement and when going from a first reference movement in progress to another reference movement in progress. The first case guarantees fluidity in the identification of the movement, the player 12 naturally going from one completed reference movement to another reference movement. The second case corresponds to performing feints, which occurs frequently in fencing. The identification method according to the fifth embodiment makes it possible to identify the movement in less than thirty seconds on a single (performance) thread of a game console. This makes it possible to reserve the other (performance) threads of the game consoles for graphics and sound. The implementation of the identification method according to the fifth embodiment is therefore transparent for the player 12. The identification method according to the fifth embodiment also makes it possible to detect the intention of the player 12. The identification method according to the fifth embodiment ensures a refined understanding of the movement to be identified as the movement by the player 12 takes place. The more time that passes, or more accurately, the further the player 12 progresses in performing his movement, the better the artificial intelligence is able to correctly analyze the movement by the player 12. This corresponds exactly to a simulation of reality. The identification method according to the fifth embodiment is able to segment the movement automatically with no indication of the beginning or end of a movement. For certain associated recognition methods, the identification method according to the fifth embodiment takes account of the fact that certain characteristic parameters of the movement to be identified by the device 16 are more or less valid. This makes it possible to guarantee a convergence of the identification method even when the provided characteristic parameters are abnormal. For certain associated recognition methods, the identification method according to the fifth embodiment has the advantage of being independent of time. Thus, it is of little importance whether the movements of the player 12 are done very quickly, very slowly, quickly at the beginning and slowly at the end or the other way around. Such variability in the performance speed has no impact on the identification, and thus on the reaction possibilities of the artificial intelligence. For certain associated recognition methods, the identification method according to the fifth embodiment also has the advantage of being independent of the morphology of the player 12. The overall differences in size or proportions, in particular relative to the width of the shoulders or the length of the arms of the player 12, are taken into account.

The identification method according to the fifth embodiment also makes it possible to obtain a computation time per temporal frame on a single (performance) thread of less than 1/30^{th} of a second for about 1000 different reference movements in the knowledge base. This makes it possible to then include, in the same temporal frame, an artificial intelligence producing a response by an opponent or allied with the character of the player 12 from recognition information and information accessible to the artificial intelligence.

For certain associated recognition methods, the identification method according to the fifth embodiment makes it possible to obtain a better identification rate than the recognition rate obtained with the identification methods of the state of the art. Typically, in the case of fencing, the identification rate is strictly greater than 85% if all of the reference movements are taken into account.

For certain associated recognition methods, the identification method according to the fifth embodiment also has the advantage of guaranteeing a maximum identification rate in the time interval during which the artificial intelligence has to make a response decision.

According to one preferred embodiment, the identification method according to the fifth embodiment is associated with the method according to the forth embodiment for according to the fifth embodiment and makes it possible to predict the likeliest future postures of the player 12 and/or the positions of the blade of the player 12 depending on the acquisition device 16 that is used. The artificial intelligence is then able to make decisions taking account of the predicted postures and/or positions. A decision for example consists of determining the most timely action among an attack, a counter-attack or a parry. According to the most highly evolved operating modes, the decision takes account of a specific behavior to simulate a human opponent. For example, to simulate an impatient human being, a counter-attack will be favored relative to a parry.

Optionally, for certain associated recognition methods, the identification method according to the fifth embodiment is able to provide an indicator of the performed movement. Such information makes it possible to obtain a performance indicator of the movement performed by the player 12. For example, the gravity of the inflicted injury is thus determined in case of an attack that is not parried or the imbalance of the opponent in case of successful parry with excellent quality. The quality indicator for the movement also makes it possible to teach the player 12 to perform the reference movements correctly. The movement quality indicator also makes it possible to facilitate the identification of later movements by the same player 12.

Advantageously, for certain associated recognition methods, the identification method according to the fifth embodiment includes a step for filtering the movements by the player 12. This for example makes it possible to favor viewing or avoid taking account of abnormal positions of certain joints.

Preferably, the identification method according to the fifth embodiment includes a step for reconstructing the identified movement(s) performed by the player 12. This makes it possible to facilitate the learning by the artificial intelligence of the specificities of the player 12, in particular the choices, strengths and past errors. According to one preferred embodiment, the artificial intelligence is able to provide the player 12 with advice to improve his practice.

To illustrate the performance that implementing the method for identifying the movement of the player 12 according to the fifth embodiment, combined when the identification step 280 is carried out using the method for identifying the movement by the player 12 according to the second embodiment, makes it possible to achieve, a concrete example implementation of such an identification method is outlined, emphasizing the obtained numerical results.

The following table gives the percentage of points correctly recognized by reference kinematics by implementing the identification method according to the fifth embodiment (second column). The following table also provides access to the percentage of points for which the reaction by the artificial intelligence resulting therefrom is most appropriate.

| | Recognition | Appropriate reaction |
|---|---|---|
| | percentage | percentage by the |
| Reference kinematics | (%) | artificial intelligence (%) |
| Manchette hit | 79.3 | 83.2 |
| Quarte hit 1 to the cheek | 89.2 | 92.4 |
| Quarte hit 1 to the leg | 88.7 | 93.2 |
| Tierce hit 2 to the cheek | 87.4 | 93.8 |
| Tierce hit 2 to the leg | 84.0 | 90.9 |
| Septime hit 3 to the cheek | 80.0 | 86.6 |
| Septime hit 3 to the leg | 77.0 | 87.9 |
| Seconde hit 4 to the cheek | 82.4 | 93.1 |
| Seconde hit 4 to the leg | 87.1 | 90.4 |
| Hit 5 to the cheek | 80.6 | 86.9 |
| Hit 5 to the side | 81.1 | 88.0 |
| Hit 6 to the cheek | 88.6 | 91.7 |
| Hit 6 to the side | 86.9 | 91.6 |
| Quinte hit 7 to the head | 87.2 | 91.3 |
| Prime hit 8 to the crotch area | 84.7 | 91.0 |
| High octave parry | 73.2 | 79.7 |
| High prime parry | 75.9 | 85.4 |
| High quarte parry | 76.8 | 84.3 |
| High seconde parry | 87.0 | 90.1 |
| High tierce parry | 68.3 | 81.1 |
| Horizontal quarte parry | 91.7 | 93.8 |
| Low prime parry | 84.9 | 93.0 |
| Low quarte parry | 83.4 | 92.2 |
| Low tierce parry | 59.2 | 63.0 |
| Octave parry | 76.7 | 82.9 |
| Prime parry | 72.8 | 82.7 |
| Quarte parry | 77.6 | 83.8 |
| Saint George parry | 80.4 | 85.9 |
| Seconde parry | 88.5 | 93.0 |
| Septime parry | 91.3 | 93.5 |
| Sixte parry | 86.1 | 92.0 |
| Tierce parry | 70.7 | 93.8 |
| En garde attack return | 6.6 | 36.9 |
| En garde parry return | 67.1 | 76.0 |

Upon studying the table, it appears that the percentage of points in time correctly recognized is 84.5% and the percentage of points in time leading to a correct response from an artificial intelligence for a fencing game (which for example does not differ in its response to a tierce parry and a sixte parry), is 90.3%. It should, however, be specified that for the points incorrectly recognized or for which the response from the artificial intelligence is not the most appropriate, this has no impact on the fencing video game inasmuch as certain phases of the fencing game, such as the guard, do not involve a specific response and the decision by the artificial intelligence to make a movement comprises several moments and not just one.

Formation of a Database

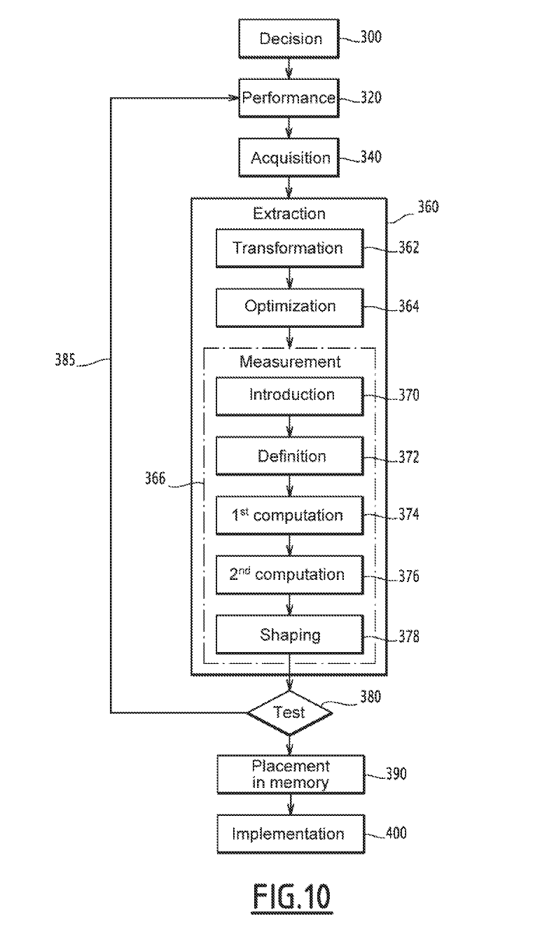

The system 10 is also able to implement a method for recognizing a movement by the player 12. An example implementation of such a recognition method is illustrated in reference to the flowchart of FIG. 10.

In the context of the description, “recognition” comprises the formation of a database and the identification of a movement. Conversely, “identification” does not include the formation of the database. The database is assumed to be provided before implementing the identification method.

Optionally, as is the case in the example of FIG. 10, the recognition method includes a decision step 300.

The decision step 300 seeks to choose a number of reference movements to be stored in the form of reference kinematics. Hereinafter, the number chosen in the decision step 300 is a strictly positive natural integer denoted I.

Preferably, the decision step 300 is carried out by a video game expert in the discipline to which the reference movements belong.

Advantageously, the choice of the number I of movements is a compromise between the speed of implementation of the recognition method and the quality of the recognition method. Indeed, the larger the number I of reference movements to be stored is, the slower the identification of the movement by the player 12 is. However, when the number I of reference movements to be stored is too low, the quality of the identification of the movement by the player 12 is insufficient for a video game application.

Preferably, the number of reference movements to be stored is greater than or equal to 20. This mathematically means that the inequality I≧20 is verified.

Advantageously, the number I of reference movements to be stored is less than or equal to 4000. This mathematically means that the inequality I≦4000 is verified. This makes it possible to retain a fast determination of the movements suitable for the speed requirements of video games.

Still more advantageously, the number I of reference movements to be stored is greater than or equal to 20 and less than or equal to 4000. This mathematically means that the inequalities 20≦I≦4000 are verified.

At the end of the decision step 300, the number I of reference movements to be stored is therefore obtained.

The recognition method also includes a step 320 for the performance by the player 12 of reference movements.

During the performance step 320, the player 12 performs all of the reference movements decided on during the decision step 300.

Preferably, the player 12 implementing the step 320 is a video game expert.

For the rest of the description, the reference movements are indexed by an index i. The index i is a positive integer comprised between 1 and I, I being the number of reference movements to be stored decided upon during the decision step 300.

Each reference movement is preferably performed several times. This makes it possible to obtain a reference kinematic that is as representative as possible of the corresponding reference movement. For the rest of the description, the performance number of each reference movement is denoted J(i). Furthermore, each performance of the reference movement i is identified hereinafter by an index denoted j. The index j is a positive integer comprised between 1 and J(i).

Preferably, J(i) is a positive integer greater than or equal to 2. Preferably, J(i) is a positive integer greater than or equal to 20.

According to one embodiment, the performance number J(i) of each reference movement is identical for all of the reference movements.

Preferably, the performed movements are recorded such that the movements of the same type correspond to different series of acquisitions.

Alternatively, step 320 is performed by several players 12 to account for the movement variations from one player 12 to the next. Typically, in the case of a fencing video game player, it is possible to consider asking several fencing players of different nationalities to perform a same reference movement. The diversity of nations would make it possible to account for differences in the performance of a same movement from one country to another, and to thus extract an average movement approaching the different types of performance as much as possible. The average movement is then qualified as “reference movement”.

The recognition method also includes a step 340 for acquisition by the device 16 of characteristic parameters relative to the reference movements performed in the performance step 320.

The acquisition step 340 and the performance step 320 are carried out simultaneously.

In the acquisition step 340, the characteristic parameters relative to the reference movements are also sent from the device 16 to the computer 14.

Thus, for example, according to one case previously outlined, for a number of parameters of three per joint with twenty joints, 60 parameters are sent by the device 16. Preferably, the 60 parameters are measured at a frequency corresponding to at least thirty points per second.

Preferably, the time interval between each acquisition of the 60 parameters is constant throughout the entire acquisition of the reference movement.

At the end of the acquisition step 360, a set of characteristic parameters acquired for each performance of the reference movement is obtained. The acquired characteristic parameters are stored in the memory 18 of the computer 14.

The recognition method also includes a step 360 for extracting a set of reference kinematics from the set of acquired characteristic parameters.

According to the specific example of FIG. 10, the step 360 includes a transformation sub-step 362, an optimization sub-step 364 and a measuring sub-step 366.

The same remarks regarding the obtainment sub-step 34 are applicable to the transformation sub-step 362.

As a result, in the transformation sub-step 362, the acquired characteristic parameters relative to a performance j of a reference movement i are transformed into a set of input parameters.

Preferably, the transformation sub-step 362 is applied for each parameter of each performance of each reference movement upon each acquisition.

According to one preferred embodiment, the input parameters are position, speed and/or articulation data of the joints.

According to another embodiment, the characteristic parameters are data specific to the movement such as the position, the curved abscissa and/or the tangent of the curve of the movement. Advantageously, the parameters are independent of the time.

Alternatively, the characteristic parameters are chosen from the group made up of speed data of the joints, acceleration data of the joints, the curved abscissa or the tangent of the curve of the movement.

The set of input parameters computed from characteristic parameters acquired upon each acquisition form a sample kinematic. A sample kinematic is a series of points, each point yielding the value of characteristic parameters at the acquisition moment of the point. Each sample kinematic corresponds to a performance j of a reference movement i.

For the continuation of the description, as an illustration, it is assumed that for each performance j of a reference movement i, one of the input parameters is the normalized direction vector of the tangent to the curve of the reference movement performed.

Alternatively, the performance method does not include a transformation sub-step 362. In this case, the acquired characteristic parameters are the input parameters. The set of characteristic parameters acquired upon each acquisition then forms a sample kinematic.

In the optimization sub-step 364, reference kinematics are computed from sample kinematics.

More specifically, for each reference movement, a reference kinematic is computed by using a cost function. Alternatively, instead of a cost function, a score, a likelihood or an a posteriori probability is used.

According to one preferred embodiment, the cost function is a function measuring the dissimilarity between the reference kinematic and the different sample kinematics associated with the same reference movement.

Preferably, the reference kinematic is computed to minimize the cost function.

In other words, the values of the parameters of the different points of the reference kinematic minimize the cost function, in light of the values of the parameters of the different points of the sample kinematics associated with the same reference movement as the computed reference kinematic.

As a result, it is preferable, provided that the sample kinematics all have the same form, i.e., the same number of characteristic points, for the reference kinematics to have the same mathematical form as the sample kinematics.

The computation is done using an optimization from an initial kinematics to arrive at an optimized kinematic corresponding to the reference kinematic. For example, the chosen initial kinematic is one of the sample kinematics obtained at the end of the transformation sub-step 362.

According to another embodiment, the chosen initial kinematic is an arithmetic mean of the sample kinematics. More generally, the initial kinematic is chosen to minimize the implementation time of the optimization sub-step 364.

According to another embodiment, the optimization sub-step 364 is a computation step without optimization. As an illustration, the reference kinematic is a mean of the sample kinematics associated with the same reference movement. This makes it possible to avoid using a cost function. The mean is for example an arithmetic mean. Advantageously, the mean is a geometric mean. Relative to the arithmetic mean, the geometric mean has the advantage of being less sensitive to any extreme values of the parameters of the sample kinematics.

According to a more developed embodiment, the mean is a weighted mean involving weighting coefficients. The weighting coefficients for example account for the uncertainty of the provided characteristic parameters. Alternatively, the weighting coefficients are optimized so that the reference kinematics have a desired property, for example a better spatial continuity. According to another embodiment, the reference kinematic is a median of the sample kinematics associated with the same reference movement.

According to another embodiment, the central trend of the central reference kinematic is made up of points in time each belonging to a sample kinematic. According to another embodiment, the reference kinematic is made up of the set of sample kinematics. According to another embodiment, the reference kinematic is, in a plane orthogonal to the central trend of the sample kinematics—for example, the mean kinematic—, the convex envelope of the sample kinematics.

According to another embodiment, the reference kinematic is obtained by extracting the singular values from the matrix containing, in one row and one column, the distance between the sample point indexed by the row and the sample point indexed by the column. According to another embodiment, the reference kinematic is obtained using a probability distribution computation technique. According to another embodiment, the reference kinematic is obtained using a blob extraction technique.

In the optimization sub-step 364, for each reference movement i, a reference kinematic is obtained. The obtained reference kinematics are stored in the memory unit 18 of the computer 14.

In the measuring sub-step 366, a dispersion measurement is computed for each reference kinematic from the considered reference kinematic and sample kinematics associated with the same reference movement. It should be noted that the central trend and dispersion information can be replaced by probability distribution information. This corresponds to the fact that the local dispersion may be computed in several different ways.

According to the specific example of FIG. 10, the measuring sub-step 366 includes an introduction sub-step 370, a definition sub-step 372, a first computation sub-step 374, a second computation sub-step 376 and a forming a sub-step 378.

In the introduction sub-step 370, a privileged vectorial space is introduced making it possible to reduce the implementation time of the measuring sub-step 366.

In the considered case in which one of the input parameters is the normalized direction vector of the tangent to the curve of the reference movement performed, the hyperplane is introduced orthogonal to the tangent of each reference movement for each reference movement.

As a reminder, in mathematics, and more particularly in linear algebra and geometry, the hyperplanes of a vectorial space E with any dimension are the generalization of the vectorial planes with dimension 3. In other words, the hyperplanes are the vectorial sub-spaces with co-dimension 1 in the vectorial space E. If the vectorial space E has a finite dimension n, the hyperplanes of the vectorial space E are all of the vectorial sub-spaces of the vectorial space E having dimension n−1.

At the end of the introduction sub-step 370, the hyperplane orthogonal to the tangent of each reference movement for each reference movement is introduced.

In the definition sub-step 372, a rotation is defined specific to each orthogonal hyperplane obtained at the end of the introduction sub-step 370.

According to one preferred embodiment, the rotation is chosen so that the image of the hyperplane orthogonal to the tangent of the movement taken at a first moment by the rotation is transformed into the hyperplane orthogonal to the tangent of the movement at a second moment.

At the end of the definition sub-step 372, a set of rotations is obtained.

Prior to computing the local dispersion, each point in time of each sample kinematic is matched with part of the reference kinematic, or with several parts of the reference kinematic, with an association measurement with each of them.

The computation of the local dispersion then depends on the depiction mode of the dispersion.

In the first computation sub-step 374, the local dispersion of each reference kinematic in the direction of the tangent to the movement at each moment is computed. For a local dispersion model chosen for the direction of the tangent, the parameters of this model are estimated for part of the reference kinematic from distances along the tangent to the part of the reference kinematic between this part of the reference kinematic and the points in time of the sample kinematics associated therewith.

According to a first embodiment, the local dispersion in the direction of the tangent is computed as the variance of the distance along the tangent between the point in time of the sample kinematic and the part of the reference kinematic associated therewith.

According to a second embodiment, a histogram of this distance is computed, for example with the Parzen method.

Many other embodiments can be considered.

The result of the computation done in the sub-step 374 is, according to one preferred embodiment, presented in matricial form.

In this case, each obtained matrix is typically a vector whose size is connected to the number of characteristic parameters obtained at the end of the transformation sub-step 362.

In the specific case where the characteristic parameters are grouped together in a group of parameters, the size of the vector is related to the cardinal of each group.

At the end of the first computation sub-step 374, the local dispersion of each reference kinematic in the direction of the tangent to the movement at each moment is obtained.

In the second computation sub-step 376, the local dispersion of each reference kinematic in the hyperplane orthogonal to the tangent to the movement at each moment is known.

To perform such a computation, the rotations obtained at the end of the definition sub-step 372 are used.

In a first embodiment, the dispersion in the hyperplane orthogonal to the tangent to the movement can be represented by a variance-covariance matrix in this hyperplane. If one supposes that the groups of characteristic parameters are independent, a variance-covariates matrix can be computed for each group of parameters. In both cases, this may optionally be reduced in the form of eigenvectors and eigenvalues.

In a second embodiment, the dispersion in the orthogonal hyperplane is represented by multidimensional histograms. In this approach, it is preferable to suppose that the groups of characteristic parameters are independent, to limit the number of dimensions of the histograms.

The result of the computation done in the sub-step 376 is, according to one preferred embodiment, presented in matricial form.

In this case, each obtained matrix is typically a square matrix whose size is connected to the number of characteristic parameters obtained at the end of the transformation sub-step 362.

In the specific case where the characteristic parameters are grouped together in a group of parameters, the size of the matrix is related to the cardinal of each group.

At the end of the second computation sub-step 376, the local dispersion of each reference kinematic in the hyperplane orthogonal to the tangent to the movement at each moment is computed.

In the forming sub-step 378, the set of dispersion measurements computed in the first computation and second computation sub-steps 374 and 376 are formed.

As previously explained, at the beginning of the implementation of the forming sub-step 378, a set of vectors and square matrices has been computed.

The vectors and matrices are then classified based on their correspondence to the reference movement for which the vector or matrix in question were computed. A number of sets of matrices and vectors equal to the number of reference movements decided upon in the decision step 300 is thus obtained. In other words, I sets of matrices and vectors are obtained.

Then, a classification based on the acquisition moment of the parameters is implemented on the I sets of matrices and vectors. A number of elements is then obtained equal to the number of reference movements decided upon multiplied by the number of acquisition moments, this number being denoted I*T, where T designates the number of acquisition moments during the performance of the reference movement. It should be noted that T may vary as a function of I.

Then, similarly, third of all, the number of input parameters obtained at the end of the transformation sub-step 362 is considered. A number of sets is then obtained equal to the number of reference movements decided upon multiplied by the number of recording moments and by the number of input parameters, i.e., I*T*E. E designates the number of input parameters obtained.

For each set obtained in the third step, a component of the vector and a matrix that are relative to the same characteristic parameter are alternately introduced into a matrix that is initially empty, for all of the characteristic parameters. The components of the vector and matrix are arranged such that the components of the vector and the diagonal elements of the matrices are on the diagonal of the matrix to be filled in. The components of the vector are placed first, as far to the top left of the matrix to be filled in as possible. The matrix is next completed by zero elements.

The matrix previously described is successively generated for each acquisition moment, then for each reference movement.

Alternatively, when relevant, the filling in of the matrix is done, group of parameters by group of parameters. This typically allows a faster implementation of the forming sub-step 378.

At the end of the implementation of the forming sub-step 378, a set of I*T*E square matrices is thus obtained constituting the dispersion measurement of each reference kinematic.

According to another embodiment, which is particularly favorable when the reference kinematic obtained at the end of the optimization sub-step 364 is a mean of the sample kinematics relative to the same reference movement, the measurement of the dispersion is a measurement of the standard deviation between the corresponding parameters of the sample kinematics for each reference movement. Alternatively, instead of the standard deviation, a variance-covariance matrix is considered. According to still another embodiment, other static measurements are used, such as measurements by quartile or interquartile deviation. Indeed, the quartile is computed as 4-quantiles. More specifically, the first quartile separates the lower 25% of the data, the second quartile is the median of the series and the third quartile separates the upper 25% of the data. The difference between the third quartile and the first quartile is called interquartile deviation; this is a dispersion criterion of the series.

At the end of the measuring sub-step 366, a dispersion measurement is obtained for each reference kinematic from the considered reference kinematic and sample kinematics associated with the same reference movement.

The recognition method also includes a step 380 for testing the validity of each reference kinematic extracted at the end of the extraction step 360.

To that end, the dispersion measured for each reference kinematic is compared to a predefined threshold.

If the dispersion of a reference kinematic is strictly above the predefined threshold, the performance 320, acquisition 340 and extraction 360 steps are reiterated for the reference movement in question, as indicated by the arrow 385 in FIG. 10. It is estimated that an excessively high dispersion is a sign that the reference kinematic is not sufficiently representative of the considered reference movement.

The reiteration is done as long as the dispersion measurement of the reference kinematic is strictly above the predefined threshold.

When the dispersion measured for each reference kinematic is below the predefined threshold, the following step of the recognition method, i.e., a step 390 for placing in memory, is implemented.

According to a more sophisticated embodiment, the predefined threshold depends on the reference kinematic in question and/or the input parameter in question. For example, if the measurement of a first input parameter is typically noisier than the measurement of a second input parameter, it is preferable to choose a different admissible dispersion threshold.

Alternatively, the recognition method does not include a measuring sub-step 366 and/or test step 380. In this case, the emphasis is placed on the performance speed of the recognition method, potentially to the detriment of the quality of the reference kinematics. This is advantageous for forming a knowledge base relative to the user of the system 10, since the dispersion is a priori less significant than for a knowledge base intended for a broader public. A fencing player 12 generally has his own style, which must be put aside to form a database allowing good later identification.

The recognition method next includes the step 390 for placing the set of reference kinematics extracted in the extraction step 360 in memory.

In the step 390 for placing in memory, the reference kinematics extracted in the extraction step 360 and the associated dispersion measurements are placed in memory in the memory unit 18 of the computer 14.

The reference kinematics form a knowledge base.

At the end of the decision 300, performance 320, acquisition 340, extraction 360, test 380 and placement in memory 390 steps, the knowledge base allowing the identification of movements has been obtained.

The recognition method lastly includes a step 400 for implementing an identification method.

For example, the identification method is the identification method according to the first embodiment as previously described in reference to FIGS. 2, 3 and 4. Alternatively, the identification method is the identification method according to the second embodiment as previously described in reference to FIGS. 2 and 5. According to another alternative, the identification method is the identification method according to the third embodiment as previously described in reference to FIGS. 6 and 7. According to still another alternative, the identification method is the identification method according to the fourth embodiment as previously described in reference to the processing method of FIG. 8.

According to another embodiment, the identification method comprises the use of the method described in reference to FIG. 9.

Preferably, in order for the formation of a knowledge base using the recognition method to be more favorable to the implementation of an identification method, the device 16 used is the same in the acquisition step 340 as in the step 400 for implementing the identification method.

According to one preferred embodiment, steps for forming a knowledge base are carried out by a video game publisher. The publisher himself performs the reference movements decided on during the decision step 300. The publisher describes the reference movements in a user manual provided with the sold video game such that the video game player 12 having purchased the published game can then effectively reproduce the reference movements.

### CONCLUSION

In the preceding, an identification method has been proposed according to five embodiments, as well as a method for forming a database.

As previously explained, each method for identifying a movement by a player 12 has a shorter computing time than the identification method according to the state of the art.

The embodiments and alternatives described above can be combined when technically possible to obtain other embodiments of the invention.

1. A method of analyzing a movement of a human being, called movement to be analyzed, the movement to be analyzed having an end, the method being implemented by a computer including a memory unit storing a set of reference kinematics, each reference kinematic being a mathematical representation in the form of a series of points of at least one reference movement, each point yielding the value of a set of parameters characteristic of the represented reference movement(s), the method including the steps of:
choosing a computing time interval,
selecting an initial probability function,
processing,
recognizing the end of the movement to be analyzed when a criterion is verified, the processing step being iterated for as long as the criterion is not verified,
determining a piece of information regarding the movement to be analyzed,
each iteration of the processing step comprising a step for:
providing a set of characteristic parameters relative to the movement to be analyzed during the chosen computing time interval,
computing a point, the computed point belonging to a reference kinematic and rendering a function depending on a posteriori conditional probability extremal, called a posteriori conditional probability function, the a posteriori conditional probability function being defined for each point as the likelihood of the considered point being part of the movement to be analyzed knowing that all of the input parameters have been supplied, the input parameters being obtained from the supplied set of characteristic parameters and the a posteriori conditional probability function being computed by implementing a quantified recursive Bayesian filtering applied to the a posteriori conditional probability functions computed in the preceding iterations of the processing step and the initial probability function, the quantification relating to the reference kinematics,
the determination step taking into account the points computed upon each iteration of the processing step.

2. The analysis method according to claim 1, wherein the analysis method is an identification method, the movement to be analyzed being a movement to be identified, the determination step being a step for determining the movement that is most representative of the movement to be identified, the most representative movement being a reference movement or a series of reference movement parts.

3. The analysis method according to claim 1, wherein the function depending on the a posteriori conditional probability function is the identity function.

4. The analysis method according to claim 1, wherein each iteration of the processing step comprises a step for obtaining input parameters from the set of provided characteristic parameters.

5. The analysis method according to claim 1, wherein the method is a method for predicting the movement to be analyzed, the information pertaining to at least one following point of the movement.

6. The analysis method according to claim 1, wherein the method is a method for filtering the movement to be analyzed.

7. The analysis method according to claim 1, wherein the input parameters are the set of provided characteristic parameters.

8. A method of recognizing a movement of a human being, called movement to be recognized, the movement to be recognized having an end, the method being implemented by an acquisition device and a computer including a memory unit, the method including the following steps:
a human being performs reference movements,
the acquisition device acquires characteristic parameters relative to the performed reference movements,
a set of reference kinematics is determined, each reference kinematic being a mathematical representation in the form of a series of points of at least one reference movement, each point yielding the value of a set of parameters characteristic of the represented reference movement(s),
the set of determined reference kinematics is placed in memory,
the steps of the analysis method according to claim 2, are carried out.

9. The analysis method according to claim 1, further comprising a computer program product including programming code instructions able to be implemented by a computer, in particular a video game for a video game console, the computer program being able to carry out the analysis method.

10. A system for identifying a movement by a human being, called movement to be identified, in particular for a video game, including:
a computer including a memory unit,
a device for acquiring a set of characteristic parameters relative to the movement to be identified, the movement having an end,
the memory unit storing a set of reference kinematics, each reference kinematic being a mathematical representation in the form of a series of points of at least one reference movement, each point yielding the value of a set of parameters characteristic of the represented reference movement(s), and the computer being able to carry out the following steps:
choosing a computing time interval,
selecting an initial probability function,
processing,
recognizing the end of the movement to be identified when a criterion is verified, the processing step being iterated for as long as the criterion is not verified,
determining the movement that is most representative of the movement to be identified, the most representative movement being a reference movement or a series of reference movement parts,
each iteration of the processing step comprising a step for:
the provision by the acquisition device of a set of characteristic parameters relative to the movement to be identified during the chosen computing time interval, computing a point, the computed point belonging to a reference kinematic and rendering a function depending on a posteriori conditional probability extremal, called a posteriori conditional probability function, the a posteriori conditional probability function being defined for each point as the likelihood of the considered point being part of the movement to be identified knowing that all of the input parameters have been supplied, the input parameters being obtained from the supplied set of characteristic parameters and the a posteriori conditional probability function being computed by implementing a quantified recursive Bayesian filtering applied to the a posteriori conditional probability functions computed in the preceding iterations of the processing step and the initial probability function, the quantification relating to the reference kinematics,
the determination step taking into account the points computed upon each iteration of the processing step.

11. The computer program product of claim 9 further comprising a support medium storing the computer program product.
